(19) United States
(12) Patent Application Publication
(10) Pub. No.: US 2019/0274917 A1
(43) Pub. Date: Sep. 12, 2019

(54) EAR THERAPEUTIC DEVICE

(71) Applicant: Vincent Yuval R&D Limited, Hug Hom, Kowloon (HK)

(72) Inventor: Yuval AVNI, Tel-Aviv (IL)

(21) Appl. No.: 16/345,912

(22) PCT Filed: Oct. 29, 2017
(86) PCT No.: PCT/IL2017/051176

§ 371 Date: Apr. 29, 2019

Related U.S. Application Data
(60) Provisional application No. 62/414,735, filed on Oct. 30, 2016.

(51) Int. Cl. A61H 21/00; A61H 9/00; A61H 23/02

(52) U.S. Cl. CPC A61H 21/00; A61H 9/005; A61H 23/0263; A61H 2201/0176; A61H 2230/405; A61H 2201/1604; A61H 2201/5005; A61H 2201/5071; A61H 2230/045; A61H 2201/1238

(57) ABSTRACT

An ear therapeutic device comprises middle ear ambient pressure equalizing means and vibrations means for providing oscillating vibrations. Middle ear pressure equalizing means comprises at least one conduit comprising at least one first end configured for receiving an airflow blown thereinto and at least one second end configured for external attachment to the ear aperture being in a fluid communication therebetween; and said vibration means induces vibrations propagating into said patient Eustachian tube.

### FIELD OF THE INVENTION

The present invention generally relates to the field of ear devices, and more particularly, the present invention pertains to an ear device, providing technological solutions that simplify treatment of ear pain/discomfort, from such as Eustachian tube dysfunctions and barotrauma, during its operation and methods thereof, comprising a device operable in a plurality of treatment protocols and sub protocols of pressure and/or oscillating vibrations.

### BACKGROUND OF THE INVENTION

The ear, as a stato-acoustic organ has two major roles: hearing and maintaining equilibrium. The ear comprises three different portions, the outer, middle, or inner ear. The outer ear is the external portion of the ear, which consists of the pinna and external auditory meatus. It gathers sound energy and focuses it on the eardrum. From the pinna the sound pressure waves move into the ear canal, also known as the external acoustic meatus a simple tube running through the middle ear. The middle ear is the portion of the ear internal to the eardrum, and external to the oval window of the inner ear. The middle ear contains three ossicles, which transfers the vibrations of the eardrum into waves in the fluid and membranes of the inner ear. The hollow space of the middle ear has also been called the tympanic cavity, or cavum tympani. The Eustachian tube joins the tympanic cavity with the nasal cavity (nasopharynx), allowing pressure to equalize between the middle ear and throat. The Eustachian tube originates in the rear of the nose adjacent to the soft palate, runs a slightly uphill course, and ends in the middle ear space. The middle ear space is the hollowed out portion of the skull bone that contains the hearing apparatus and is covered on one side by the eardrum. The inner ear (auris interna) is the innermost part of the vertebrate ear. It is mainly responsible for sound detection and balance. It consists of the bony labyrinth, comprising two main functional parts: the cochlea, dedicated to hearing; converting sound pressure patterns from the outer ear into electrochemical impulses which are passed on to the brain via the auditory nerve, and the vestibular system, dedicated to balance.

Otalgia, ear pain, is a very common symptom of various conditions and diseases. It can originate from the different portions of the ear, or referred to from an external location such as from the jaw area.

Two of the most prominent pain symptoms are related to the Middle ear. These include pain originating from mechanical conditions such as Eustachian tube obstruction, barotrauma, or inflammatory conditions originating in infection. Ear infections can occur as side effects of contagious illnesses—colds, coughs, or eye ailments. The tissue that lines the Eustachian tube is similar to that inside the nasal cavity and may respond the same way (swelling) when presented with similar stimuli.

The main functions of the Eustachian tube, as known in the art are: to ventilate the middle ear space, ensuring that its pressure remains at near normal environmental air pressure, and to drain any accumulated secretions, infection, or debris from the middle ear space. Several small muscles located in the back of the throat and palate control the opening and closing of the tube. Swallowing and yawning cause contractions of these muscles located in the back of the throat and help regulate Eustachian tube function. Normally, the Eustachian tube is closed, which helps prevent the inadvertent contamination of the middle ear space by the normal secretions found in the back of the nose.

Eustachian tube dysfunction (ETD) occurs when the tube fails to open during swallowing or yawning. This results in a difference between the air pressure inside and outside the middle ear. ETD is caused by poor function or blockage of the Eustachian tube, including: inability of the tiny hairs inside the ear to remove fluid and infection; poor squeezing function within the Eustachian tube; narrow Eustachian tube in infants; adenoid tissue blocking Eustachian tube in children; swollen nasal secretions that cause a blockage; and, tumors in adults.

Factors that may increase your chance of getting ETD include: age (children), nasal congestion from an allergy, cold other upper respiratory infection, ear or sinus infections, environmental allergies, children with large adenoids, activities with large rapid altitude changes (flying or scuba diving), and presence of obstructing tumors in the nasopharynx. Symptoms can include: feeling of fullness or clogging in the ear, discomfort or ear pain, hearing loss, ear ringing, a sensation of spinning known as vertigo, pain if the blockage results in an infection.

Ear barotrauma is discomfort and possible damage in the ear due to pressure differences between the inside and outside of the eardrum. Barotrauma can originate from the common problem of failure of the Eustachian tube to effectively regulate air pressure. Partial or complete blockage of the Eustachian tube, whether cold related or constructional abnormality, can cause sensations of popping, clicking, and ear fullness and occasionally moderate to severe ear pain. Such intense pain is most frequently experienced during sudden air pressure changes during airplane travel, scuba diving, or driving in the mountains. As air pressure in the middle ear falls, and the ear feels full and sounds are perceived as muffled. Eventually, a vacuum is created which can then cause fluid to be drawn into the middle ear space (termed serous otitis media). If the fluid becomes infected, the common ear infection develops. Other symptoms include dizziness, hear loss (from slight to severe), ear discomfort and nose bleed.

Therefore, there is a long felt and unmet need for a device that provides pain relief and aids in recovery of middle ear related conditions in a simple and safe manner, to be used both by medical personal and by patients in their home.

### SUMMARY OF THE INVENTION

The present invention provides an ear therapeutic device (ETD) (100), useful for providing artificially induced vibrations, pneumatic pressure, or both, to at least a portion of a patient's ear, comprising: (a) middle ear ambient pressure equalizing means (500); (b) one or more vibrations means (400) for providing oscillating vibrations to at least a portion of said patients head; wherein middle ear pressure equalizing means comprises at least one conduit (300) comprising at least one first end (127) configured for external attachment to the mouth aperture and at least one second end (126) configured for external attachment to the ear aperture, said conduit configured to permit fluid communication therebetween and said vibration means (400) is configured to propagate artificially induced vibrations along said conduit and into said patient Eustachian tube (1000).

The present invention provides an ear therapeutic device (ETD), useful for providing artificially induced vibrations, pneumatic pressure, or both, to at least a portion of a patient's ear, comprising: (a) middle ear ambient pressure equalizing means (500); (b) one or more vibrations means (400) for providing oscillating vibrations to at least a portion of said patients head; wherein middle ear pressure equalizing means comprises at least one conduit (300) comprising at least one first end (127) configured for external attachment to at least one said pressure equalizing means and at least one second end (126) configured for external attachment to the ear aperture, said conduit configured to permit fluid communication therebetween, and said vibration means is configured to propagate artificially induced vibrations along said conduit and into said patient Eustachian tube (1000).

It is another object of the present invention to disclose the ETD as defined in any of the above, wherein the ETD is configured to provide one or more protocols comprising administration of a selected from a group consisting of: the oscillating vibrations by one or more vibrations means, pressure by at one or more the pressure equalizing means, and any combination thereof.

It is another object of the present invention to disclose the ETD as defined in any of the above, wherein the one or more protocols comprises at least one sub protocol.

It is another object of the present invention to disclose the ETD as defined in any of the above, wherein the sub protocols comprise vibration producing oscillations, pneumatic pressure, or both, administered individually or simultaneously.

It is another object of the present invention to disclose the ETD as defined in any of the above, wherein one or more the sub protocol further comprising administration of the vibrations, the pressure, or both, in a manner selected from a group consisting of: constant, intermittent, pulsating, arbitrary, or any combination thereof.

It is another object of the present invention to disclose the ETD as defined in any of the above, wherein one or more the sub protocol further provides administration of the pressure, the vibrations, or both, comprising at least one variable parameter selected from a group consisting of: amplitude, velocity, frequency, wave length, wave forms, duration, direction, and any combination thereof.

It is another object of the present invention to disclose the ETD as defined in any of the above, wherein at least one of the wave forms is selected from a group consisting of: sine wave, linear wave, curved wave, triangular wave, rectangular wave, square wave, saw-tooth wave, trapezoid wave, and any combination thereof.

It is another object of the present invention to disclose the ETD as defined in any of the above, wherein the wave comprises at least one component selected from a group consisting of: harmonic frequencies, non-harmonic frequencies, acoustic waves, non-acoustic waves, and any combination thereof.

It is another object of the present invention to disclose the ETD as defined in any of the above, wherein the pressure provided by one or more the sub protocol is positive pressure, negative pressure or a combination sequence of both.

It is another object of the present invention to disclose the ETD as defined in any of the above, wherein one or more the sub protocol further comprising administration of a plurality of the vibrations by one or more the vibration means, such that each vibration differs by at least one parameter selected from a group consisting of: amplitude, velocity, frequency, wave length, wave forms, duration, direction, and any combination thereof.

It is another object of the present invention to disclose the ETD as defined in any of the above, wherein one or more the sub protocol further comprising administration of a plurality of the pressure by one or more the pressure equalizing means, such that each administered pressure differs by at least one parameter selected from a group consisting of: amplitude, velocity, frequency, wave length, wave forms, duration, direction, and any combination thereof.

It is another object of the present invention to disclose the ETD as defined in any of the above, wherein the protocols, sub protocols or both are selected from a group consisting of: defined by medical care, predefined by the manufacturer, manually configured by the user, and any combination thereof.

It is another object of the present invention to disclose the ETD as defined in any of the above, wherein the ETD further comprises at least one patient interfacing piece configured to be reversibly attached to at least a portion of a patient's organ selected from a group consisting of: nose, nasal bridge, nostril, ear, ear canal, cheek, forehead, temple, neck, inner throat, head, mouth, philtrum, glabella, nasion, chin, face, jaw, and any combination thereof.

It is another object of the present invention to disclose the ETD as defined in any of the above, wherein the patient interfacing piece comprises at least one aperture, configured to permit fluid communication therethrough.

It is another object of the present invention to disclose the ETD as defined in any of the above, wherein the patient interfacing piece is configured to at least partially seal a patient's aperture selected from a group consisting of: mouth, at least one nostril, external auditory ear canal, ear, nose, and any combination thereof from fluid communication with the external air.

It is another object of the present invention to disclose the ETD as defined in any of the above, wherein the device further comprises at least one element, connected to at least one conduit end, selected from a group consisting of: (a) a mouth piece (110) configured to permit fluid communication from the patient's or user's mouth to the conduit; (b) an ear piece (122, 120, 125) configured to at least partially seal the patient's ear canal from air external to the conduit and permit fluid communication from the conduit to the patient's ear; (c) a connection to an external pneumatic pressure means selected from a group consisting of: a pneumatic compressor, a manual pump, an automatic pump, an air blower, vacuum, bellow, piston, flexible bag, and any combination thereof; (d) a nose piece (200) configured to permit fluid communication into and out of the patient's nose and through the conduit; (e) a reversibly attachable facial mask (130) configured to at least partially seal at least a portion of the patient face from external air, configured to permit fluid communication to at least a portion of the patients face from the conduit; and any combination thereof.

It is another object of the present invention to disclose the ETD as defined in any of the above, wherein the conduit further comprises at least one turnable hinge (68), such that the orientation of a selected from a group consisting of: the mouth piece, the ear piece, the nose piece, the facial mask, and any combination thereof, is adjustable.

It is another object of the present invention to disclose the ETD as defined in any of the above, wherein at least a portion of the conduit is made of a selected from a group consisting of: flexible material, at least partially transparent material, sterilizable material, disposable material, and any combination thereof.

It is another object of the present invention to disclose the ETD as defined in any of the above, wherein the fluid communication is configured to be bi-directional, unidirectional, or both.

It is another object of the present invention to disclose the ETD as defined in any of the above, wherein the ETD further comprises at least one valve configured to regulate the pressure administered by the pressure equalizing means.

It is another object of the present invention to disclose the ETD as defined in any of the above, wherein one or more the valve is selected from a group consisting of: a pressure tuning valve, a pressure release valve, a pressure buildup valve, and any combination thereof.

It is another object of the present invention to disclose the ETD as defined in any of the above, wherein one or more valve is operated in a manner selected from a group consisting of: by an operating system, automatically according to predefined parameters, manually, and any combination thereof.

It is another object of the present invention to disclose the ETD as defined in any of the above, wherein the conduit comprises at least one pressure regulating valve operative by the patient inhaling, exhaling, or both.

It is another object of the present invention to disclose the ETD as defined in any of the above, wherein the conduit comprises at least on/off switch configured to be controlled by the patient inhaling, exhaling or both.

It is another object of the present invention to disclose the ETD as defined in any of the above, wherein the ETD is configured to be controlled by a selected from a group consisting of: a remote control, a remote computer, a cellular phone, a PDA, a tablet, cloud computing, remote server, and any combination thereof.

It is another object of the present invention to disclose the ETD as defined in any of the above, wherein the device further comprises at least one operating system configured to control a selected from a group consisting of: one or more the vibration means, one or more the pressure equalizing means, one or more the valves, and any combination thereof.

It is another object of the present invention to disclose the ETD as defined in any of the above, wherein the operating system is configured to control the vibration parameter selected from a group consisting of: amplitude, frequency, duration, velocity, wavelength, waveform, and any combination thereof.

It is another object of the present invention to disclose the ETD as defined in any of the above, wherein the device comprises at least one first vibration means and at least one second vibration means, further wherein the control system is configured to control each vibration means independently.

It is another object of the present invention to disclose the ETD as defined in any of the above, wherein at least one first the vibration means and at least one second the vibration means are configured to operate at least partially simultaneously thereby administering wave interference vibrations to the patient.

It is another object of the present invention to disclose the ETD as defined in any of the above, wherein at least one first vibration means and at least one second vibration means are configured to operate provide each a different vector vibration.

It is another object of the present invention to disclose the ETD as defined in any of the above, wherein the operating system is configured to provide vibration, pneumatic pressure, or both by controlling at least one vibration means, pressure means or both.

It is another object of the present invention to disclose the ETD as defined in any of the above, wherein the operating system comprises at least one user interface.

It is another object of the present invention to disclose the ETD as defined in any of the above, wherein the operating system is controlled manually, automatically, or both.

It is another object of the present invention to disclose the ETD as defined in any of the above, wherein the operating system is controlled by a selected from a group consisting of: the patient's breathing, the patient's exhaling, the patients inhaling, the patient forcibly blowing air, voice activation, hand operation, and any combination thereof.

It is another object of the present invention to disclose the ETD as defined in any of the above, wherein the vibration means is configured to provide vibrations at a set of frequencies ranging from about 0.1 Hz to about 20 KHz.

It is another object of the present invention to disclose the ETD as defined in any of the above, wherein the vibration means is configured to provide vibration of at least one frequency in a value ranging from about 0.1 Hz to about 20 KHz.

It is another object of the present invention to disclose the ETD as defined in any of the above, wherein the vibration means are selected from a group consisting of: at last one vibrator, at least one acoustic generator, at least one eccentric weight, at least one piston, at least one shaker, and any combination thereof.

It is another object of the present invention to disclose the ETD as defined in any of the above, wherein the vibration means are configured to provide vibrations in interval frequencies of 0.5 Hz.

It is another object of the present invention to disclose the ETD as defined in any of the above, wherein the pressure means are configured to provide pressure ranging from about (−) 100 cmH₂O to about (+) 100 cmH₂O.

It is another object of the present invention to disclose the ETD as defined in any of the above, wherein the ETD comprises at least one sensor selected from a group consisting of: a patient monitoring sensor, a pressure sensor, a vibration sensor, and any combination thereof.

It is another object of the present invention to disclose the ETD as defined in any of the above, wherein the patient monitoring sensor is selected from a group consisting of: an ear drum pressure sensor, a tissue vibration sensor, a breathing sensor, a cardiovascular sensor, a pressure sensor, and any combination thereof.

It is another object of the present invention to disclose the ETD as defined in any of the above, wherein the sensor is configured to relay sensed information to at least one indicator selected from a group consisting of: auditable, sensible, visual, and any combination thereof.

It is another object of the present invention to disclose the ETD as defined in any of the above, wherein the sensor is configured to relay sensed information to the operating system.

It is another object of the present invention to disclose the ETD as defined in any of the above, wherein the one or more pressure equalizing means is configured to provide positive pressure, negative pressure, or both.

It is another object of the present invention to disclose the ETD as defined in any of the above, wherein the pressure equalizing means is selected from a group consisting of: at least one automatic air pump, at least one manual pneumatic pump, a vent, at least one air blowing device, the patient's inhaling/exhaling, the patient respiratory system, piston, bellow, flexible bag, and any combination thereof.

It is another object of the present invention to disclose the ETD as defined in any of the above, wherein the ETD further comprises at least one data logger.

It is another object of the present invention to disclose the ETD as defined in any of the above, wherein the device further comprises at least one processor in communication with a computer readable medium (CRM); the processor executes a set of operations received from the CRM; the set of operations are (a) receiving a treatment protocol; and, (b) operating a selected from a group consisting of: the pressure equalizing means, the vibration means, at least one valve, and any combination thereof according to the treatment protocol.

It is another object of the present invention to disclose the ETD as defined in any of the above, wherein the device further executes the following set of operations: (a) receiving information values relayed by at least one sensor; (b) comparing the information values relayed by at least one sensor to the operated treatment protocol values; and, (c) if information relayed by at least one sensor is different than information values of the treatment protocol, adjusting the values operated by a selected from a groups consisting of: the pressure equalizing means, the vibration means, at least one valve, and any combination thereof.

It is another object of the present invention to disclose the ETD as defined in any of the above, wherein the device further comprises wireless communication means, wired communication means or both.

It is another object of the present invention to disclose the ETD as defined in any of the above, wherein the wireless communication means are selected from a group consisting of: receiver, transmitter, transceiver, blue tooth system, cellular phone, Wi-Fi system, and any combination thereof.

It is another object of the present invention to disclose the ETD as defined in any of the above, wherein the device further comprises at least one emergency shutoff mechanism.

It is another object of the present invention to disclose the ETD as defined in any of the above, wherein the emergency mechanism is configured to stop the vibration, air pressure or both when detecting at least one of the following: (a) the pressure equalizing means providing pressure higher or lower than a predefined value range; (b) the vibration means providing vibration having a parameter selected from a group consisting of: frequency, duration, amplitude, waveform, wavelength, and any combination thereof, is of a value lower or higher than a predefined value range; and, (c) at least one sensor is sensing a value lower or higher than a predefined value range.

The present invention provides a method for equalizing ear pressure, wherein the method comprising steps of: (a) obtaining an ear therapeutic device (ETD) (100), useful for providing artificially induced vibrations, pneumatic pressure, or both, to at least a portion of a patient's ear, comprising: (i) middle ear ambient pressure equalizing means (500); (ii) at least one conduit (300) comprising at least one first end (127) configured for external attachment to the mouth aperture and at least one second end (126) configured for external attachment to the ear aperture, the conduit configured to permit fluid communication therebetween; (iii) one or more vibrations means (400) for providing oscillating vibrations to at least a portion of the patients head; (b) reversibly attaching at least a portion of one end to at least a portion of the patient's mouth and at least a portion of the second end to at least a portion of the patient's ear; and, (c) administering at least one of: (i) exhaling into the conduit through at least one first the conduit end (127), thereby administering equalizing pressure to the patient' ear; and, (ii) operating at least one vibration means (400) for administering oscillating vibration, thereby propagating artificially induced vibrations along the conduit and into the patient Eustachian tube (1000).

The present invention provides a method for equalizing ear pressure, wherein the method comprising steps of: (a) obtaining an ear therapeutic device (ETD) (100), useful for providing artificially induced vibrations, pneumatic pressure, or both, to at least a portion of a patient's ear, comprising: (i) middle ear ambient pressure equalizing means (500); (ii) at least one conduit (300) comprising at least one first end (127) configured for external attachment to at least one pressure equalizing means and at least one second end (126) configured for external attachment to the ear aperture, the conduit (300) configured to permit fluid communication therebetween; (iii) one or more vibrations means (400) for providing oscillating vibrations to at least a portion of the patients head; (b) reversibly attaching at least a portion of one end (126) to at least a portion of the patient's ear; and, (c) administering at least one of: (i) administering pneumatic pressure by at least one pressure equalizing device through at least one first the conduit end (127), thereby administering equalizing pressure to the patient' ear; (ii) operating at least one vibration means (400) for administering oscillating vibration, thereby propagating artificially induced vibrations along the conduit and into the patient Eustachian tube (1000).

The present invention provides a method for equalizing ear pressure, wherein the method comprising steps of: (a) obtaining an ear therapeutic device (ETD) (1000), useful for providing pneumatic pressure, to at least a portion of a patient's ear, comprising: (i) middle ear ambient pressure equalizing means (500), (ii) at least one conduit (300) comprising at least one first end (110) configured for external attachment to at least one pressure equalizing means and at least one second end (126) configured for external attachment to the ear aperture, the conduit (300) configured to permit fluid communication therebetween; (b) reversibly attaching at least a portion of one end (126) to at least a portion of the patient's ear; and, (c) exhaling into the conduit (300) through at least one first the conduit end (110), thereby administering equalizing pressure to the patient' ear.

It is another object of the present invention to disclose the method as defined in any of the above, additionally comprising the step of providing the ETD comprising at least one vibration means for administering oscillating vibration, and administering oscillating vibrations, thereby propagating artificially induced vibrations along the conduit and into the patient Eustachian tube;

It is another object of the present invention to disclose the method as defined in any of the above, additionally comprising the step of configuring the ETD to providing one or more protocols comprising administering a selected from a group consisting of: the oscillating vibrations by one or more vibrations means, pressure by at one or more the pressure equalizing means, and any combination thereof.

It is another object of the present invention to disclose the method as defined in any of the above, additionally comprising the step of administering the one or more protocols comprising at least one sub protocol.

It is another object of the present invention to disclose the method as defined in any of the above, additionally comprising the step of providing the sub protocols comprising vibration producing oscillations, pneumatic pressure, or both, and administering the sub protocols individually or simultaneously.

It is another object of the present invention to disclose the method as defined in any of the above, additionally comprising the step of providing one or more the sub protocol further comprising administering the vibrations, the pressure, or both, in a manner selected from a group consisting of: constant, intermittent, pulsating, arbitrary, or any combination thereof.

It is another object of the present invention to disclose the method as defined in any of the above, additionally comprising the step of providing one or more the sub protocol administering the pressure, the vibrations, or both, comprising at least one variable parameter selected from a group consisting of: amplitude, velocity, frequency, wave length, wave forms, duration, direction, and any combination thereof.

It is another object of the present invention to disclose the method as defined in any of the above, additionally comprising the step of providing at least one wave form selected from a group consisting of: sine wave, linear wave, curved wave, triangular wave, rectangular wave, square wave, saw-tooth wave, trapezoid wave, and any combination thereof.

It is another object of the present invention to disclose the method as defined in any of the above, additionally comprising the step of providing the wave comprising at least one component selected from a group consisting of: harmonic frequencies, non-harmonic frequencies, acoustic waves, non-acoustic waves, and any combination thereof.

It is another object of the present invention to disclose the method as defined in any of the above, additionally comprising the step of providing one or more the sub protocol administering positive pressure, negative pressure or a combination sequence of both.

It is another object of the present invention to disclose the method as defined in any of the above, additionally comprising the step of providing one or more the sub protocol further comprising administering a plurality of the vibrations by one or more the vibration means, such that each vibration differs by at least one parameter selected from a group consisting of: amplitude, velocity, frequency, wave length, wave forms, duration, direction, and any combination thereof.

It is another object of the present invention to disclose the method as defined in any of the above, additionally comprising the step of providing one or more the sub protocol further comprising administering a plurality of the pressure by one or more the pressure equalizing means, such that each administered pressure differs by at least one parameter selected from a group consisting of: amplitude, velocity, frequency, wave length, wave forms, duration, direction, and any combination thereof.

It is another object of the present invention to disclose the method as defined in any of the above, additionally comprising the step of selecting the protocols, sub protocols or both from a group consisting of: defined by medical care, predefined by the manufacturer, manually configured by the user, and any combination thereof.

It is another object of the present invention to disclose the method as defined in any of the above, additionally comprising the step of providing the ETD further comprising at least one patient interfacing piece configured to be reversibly attached to at least a portion of a patient's organ selected from a group consisting of: nose, nasal bridge, nostril, ear, ear canal, cheek, forehead, temple, neck, inner throat, head, mouth, philtrum, glabella, nasion, chin, face, jaw, and any combination thereof.

It is another object of the present invention to disclose the method as defined in any of the above, additionally comprising the step of providing the patient interfacing piece comprising at least one aperture, configured to permit fluid communication therethrough, and administrating fluid communication therethrough by at least one pressure equalizing means.

It is another object of the present invention to disclose the method as defined in any of the above, additionally comprising the step of providing the patient interfacing piece configured to at least partially seal a patient's aperture selected from a group consisting of: mouth, at least one nostril, external auditory ear canal, ear, nose, and any combination thereof from fluid communication with the external air, and at least partially sealing the patient aperture.

It is another object of the present invention to disclose the method as defined in any of the above, additionally comprising the step of providing the ETD further comprising at least one element, reversibly connected to at least one conduit end, selected from a group consisting of: (a) a mouth piece configured to permit fluid communication from the patient's or user's mouth to the conduit; (b) an ear piece configured to at least partially seal the patient's ear canal from air external to the conduit and permit fluid communication from the conduit aperture to the patient's ear; (c) a connection to an external pneumatic pressure means selected from a group consisting of: a pneumatic compressor, a manual pump, an automatic pump, an air blower, vacuum, and any combination thereof (d) a nose piece configured to permit fluid communication into and out of the patient's nose and through the conduit; (e) an attachable facial mask configured to at least partially seal at least a portion of the patient face from external air, configured to permit fluid communication to at least a portion of the patients face from the conduit; and any combination thereof and, reversibly attaching the element to the conduit end.

It is another object of the present invention to disclose the method as defined in any of the above, additionally comprising the steps of: (a) providing the ETD further comprising at least one mouth piece, connected to the one first conduit end configured to permit the passage of air from the patient's mouth to at least one second aperture, at least one second conduit end further comprising at least one ear piece configured to at least partially seal the ear canal from air, and permit the passage of pneumatic pressure from the conduit aperture to the patient's ear canal; (b) attaching at least a portion of the mouth piece to the patient's/user's mouth, and at least a portion of the ear piece to the patient ear; and, (c) administering equalizing pressure by inhaling, exhaling, or both into the mouth piece.

It is another object of the present invention to disclose the method as defined in any of the above, additionally comprising the step of providing the conduit further comprising at least one turnable hinge, and turning the hinge, thereby changing the orientation of a selected from a group consisting of: the mouth piece, the ear piece, the nose piece, the facial mask, and any combination thereof.

It is another object of the present invention to disclose the method as defined in any of the above, additionally comprising the step of providing at least a portion of the conduit made of a selected from a group consisting of: flexible material, at least partially transparent material, sterilizable material, disposable material, and any combination thereof.

It is another object of the present invention to disclose the method as defined in any of the above, additionally comprising the step of configuring the fluid communication to be bi-directional, unidirectional, or both.

It is another object of the present invention to disclose the method as defined in any of the above, additionally comprising the step of providing the ETD further comprising at least one valve, and configuring the valve to regulate the pressure administered by the pressure equalizing means.

It is another object of the present invention to disclose the method as defined in any of the above, additionally comprising the step of regulating the pressure administered by the pressure equalizing means by at least one valve.

It is another object of the present invention to disclose the method as defined in any of the above, additionally comprising the step of selecting one or more the valve from a group consisting of: a pressure tuning valve, a pressure release valve, a pressure buildup valve, and any combination thereof.

It is another object of the present invention to disclose the method as defined in any of the above, additionally comprising the step of operating one or more valve in a manner selected from a group consisting of: by an operating system, automatically according to predefined parameters, manually, by a user's respiratory system, and any combination thereof.

It is another object of the present invention to disclose the method as defined in any of the above, additionally comprising the step of operating one or more pressure equalizing means in a manner selected from a group consisting of: by an operating system, automatically according to predefined parameters, manually, by a user's respiratory system, and any combination thereof.

It is another object of the present invention to disclose the method as defined in any of the above, additionally comprising the step of operating at least one pressure regulating valve by the patient inhaling, exhaling, or both.

It is another object of the present invention to disclose the method as defined in any of the above, additionally comprising the step of operating at least one ETD on/off switch configured by the patient inhaling, exhaling or both.

It is another object of the present invention to disclose the method as defined in any of the above, additionally comprising the step of controlling the ETD by a selected from a group consisting of: a remote control, a remote computer, a cellular phone, a PDA, a tablet, cloud computing, remote server, and any combination thereof.

It is another object of the present invention to disclose the method as defined in any of the above, additionally comprising the step of providing the ETD further comprises at least one operating system configured to control a selected from a group consisting of: one or more the vibration means, one or more the pressure equalizing means, one or more the valves, and any combination thereof, and controlling the ETD by the operating system.

It is another object of the present invention to disclose the method as defined in any of the above, additionally comprising the step of configuring the operating system to control the vibration parameter selected from a group consisting of: amplitude, frequency, duration, velocity, wavelength, waveform, and any combination thereof, and controlling the parameter.

It is another object of the present invention to disclose the method as defined in any of the above, additionally comprising the step of providing the ETD comprising at least one first vibration means and at least one second vibration means, and controlling each vibration means independently, by the operating system.

It is another object of the present invention to disclose the method as defined in any of the above, additionally comprising the step of configuring at least one first the vibration means and at least one second the vibration means to operating at least partially simultaneously, thereby administering wave interference vibrations to the patient.

It is another object of the present invention to disclose the method as defined in any of the above, additionally comprising the step of configuring at least one first vibration means and at least one second vibration means to providing each a different vector vibration.

It is another object of the present invention to disclose the method as defined in any of the above, additionally comprising the step of the operating system is configured to provide vibration, pneumatic pressure, or both by controlling at least one vibration means, pressure means or both.

It is another object of the present invention to disclose the method as defined in any of the above, additionally comprising the step of controlling the operating system by at least one user interface.

It is another object of the present invention to disclose the method as defined in any of the above, additionally comprising the step of controlling the operating system manually, automatically, or both.

It is another object of the present invention to disclose the method as defined in any of the above, additionally comprising the step of controlling the operating system by a selected from a group consisting of: the patient's breathing, the patient's exhaling, the patients inhaling, the patient forcibly blowing air, voice activation, hand operation, and any combination thereof.

It is another object of the present invention to disclose the method as defined in any of the above, additionally comprising the step of administering vibrations by the vibration means at a set of frequencies, at least one frequency, or both, in a value ranging from about 0.1 Hz to about 20 KHz.

It is another object of the present invention to disclose the method as defined in any of the above, additionally comprising the step of providing the vibration means selected from a group consisting of: at last one vibrator, at least one acoustic generator, at least one eccentric weight, at least one piston, at least one shaker, and any combination thereof.

It is another object of the present invention to disclose the method as defined in any of the above, additionally comprising the step of the vibration means are configured to provide vibrations in interval frequencies of 0.5 Hz.

It is another object of the present invention to disclose the method as defined in any of the above, additionally comprising the step of the pressure means are configured to provide pressure ranging from about (−) 100 cmH₂O to about (+) 100 cmH₂O.

It is another object of the present invention to disclose the method as defined in any of the above, additionally comprising the step of providing the ETD further comprising at least one sensor selected from a group consisting of: a patient monitoring sensor, a pressure sensor, a vibration sensor, and any combination thereof.

It is another object of the present invention to disclose the method as defined in any of the above, additionally comprising the step of providing the patient monitoring sensor selected from a group consisting of: an ear drum pressure sensor, a tissue vibration sensor, a breathing sensor, a cardiovascular sensor, a pressure sensor, and any combination thereof.

It is another object of the present invention to disclose the method as defined in any of the above, additionally comprising the step of relaying information sensed by the sensor to at least one indicator selected from a group consisting of: auditable, sensible, visual, and any combination thereof.

It is another object of the present invention to disclose the method as defined in any of the above, additionally comprising the step of relaying information sensed by the sensor to the operating system.

It is another object of the present invention to disclose the method as defined in any of the above, additionally comprising the step of administering positive pressure, negative pressure, or both, by the one or more pressure equalizing means.

It is another object of the present invention to disclose the method as defined in any of the above, additionally comprising the step of providing the pressure equalizing means selected from a group consisting of: at least one automatic air pump, at least one manual pneumatic pump, a vent, at least one air blowing device, the patient's inhaling/exhaling, the patient respiratory system, bellow, piston, flexible bag, and any combination thereof.

It is another object of the present invention to disclose the method as defined in any of the above, additionally comprising the step of providing the ETD further comprising at least one data logger, and recording by the data logger data selected from a group consisting of: time of ETD operation, date of ETD operation, duration of ETD operation, protocol administered by the ETD, sub protocol administered by the ETD, configurations applied to ETD, configurations applied to at least one protocol, sub protocol or both, information sensed by at least one of the sensors, and any combination thereof.

It is another object of the present invention to disclose the method as defined in any of the above, additionally comprising the step of providing the ETD further comprising at least one processor in communication with a computer readable medium (CRM); the processor executes a set of operations received from the CRM; the set of operations are: (a) receiving a treatment protocol; (b) operating a selected from a group consisting of: the pressure equalizing means, the vibration means, at least one valve, and any combination thereof according to the treatment protocol; and, (c) executing the operations.

It is another object of the present invention to disclose the method as defined in any of the above, additionally comprising the steps of executing the following set of operations: (a) receiving information values relayed by at least one sensor; (b) comparing the information values relayed by at least one sensor to the operated treatment protocol values; and, (c) if information relayed by at least one sensor is different than information values of the treatment protocol, adjusting the values operated by a selected from a groups consisting of: the pressure equalizing means, the vibration means, at least one valve, and any combination thereof.

It is another object of the present invention to disclose the method as defined in any of the above, additionally comprising the step of providing the ETD further comprising wireless communication means, wired communication means or both.

It is another object of the present invention to disclose the method as defined in any of the above, additionally comprising the step of selecting the wireless communication means from a group consisting of: receiver, transmitter, transceiver, blue tooth system, cellular phone, Wi-Fi system, and any combination thereof.

It is another object of the present invention to disclose the method as defined in any of the above, additionally comprising the step of providing the ETD further comprising at least one emergency shutoff mechanism.

It is another object of the present invention to disclose the method as defined in any of the above, additionally comprising the step of configuring the emergency mechanism to stop the vibration, air pressure or both when detecting at least one of the following: (a) the pressure equalizing means providing pressure higher or lower than a predefined value range; (b) the vibration means providing vibration having a parameter selected from a group consisting of: frequency, duration, amplitude, waveform, wavelength, and any combination thereof, is of a value lower or higher than a predefined value range; and, (c) at least one sensor is sensing a value lower or higher than a predefined value range.

### BRIEF DESCRIPTION OF THE FIGURES

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured. In the accompanying drawing:

FIG. 1 is a schematic illustration of an embodiment of the ear therapeutic device.

FIG. 2 is a schematic illustration, in an out of scale manner of various ear drum positions.

FIG. 3A-3B are schematic, out of scale, illustration of embodiments of a mouth piece of the invention.

FIG. 4A is a schematic illustration, in an out of scale manner of an embodiment of an ear therapeutic device for self-use.

FIG. 4B is a schematic illustration, in an out of scale manner of an embodiment of an ear therapeutic device for operation by a care taker.

FIG. 4C is a schematic illustration, in an out of scale manner of an embodiment of an ear device having a flexible portion and a turnable hinge.

FIG. 5A-B are schematic illustrations, in an out of scale manner of different embodiments of the invention comprising a nose mask.

FIG. 5C-D are schematic illustrations, in an out of scale manner of different embodiments of the invention comprising a nostril apparatus.

FIG. 6A is a schematic illustration, in an out of scale manner of an embodiment of the invention comprising a pressure control device.

FIG. 6B-D are schematic illustrations, in an out of scale manner of various embodiments of the pressure controller.

FIG. 7A-B are schematic illustrations, in an out of scale manner of various embodiments of pressure providing means.

FIG. 8 is a schematic illustration, in an out of scale manner of an embodiment of the invention comprising a conduit having three apertures, useful for providing pressure to the Eustachian tube from the ear connecting side and from the throat connecting side via the nasal cavity.

FIG. 9A is a schematic illustration, in an out of scale manner of an embodiment of the present invention worn by a patient, and connected to the patient's mouth and ear.

FIG. 9B is a schematic illustration, in an out of scale manner of an embodiment of the present invention worn by a patient, and connected to the patient's mouth, nose and ear.

FIG. 10A is a schematic illustration, in an out of scale manner of an embodiment of the present invention operable by the patient's inhaling and exhaling, comprising an earphone.

FIG. 10B is a schematic illustration, in an out of scale manner of an embodiment of the present invention, operable by the patient's inhaling and exhaling, comprising an at least partial facial cover.

FIG. 11A-B is a schematic illustration, in an out of scale manner of an embodiment of the invention comprising inhalation and exhalation valves.

FIG. 12 A-B are schematic illustrations, in an out of scale manner of different embodiments of the invention comprising an ear vibrator.

FIG. 13 is a schematic illustration, in an out of scale manner of an embodiment of the top view of the invention, comprising pneumatic pressure means and vibration means.

FIG. 14 A-C are schematic illustrations, in an out of scale manner of different embodiments of the invention comprising an inflatable membrane and oscillating vibration providing means.

FIG. 15 is a schematic illustration, in an out of scale manner of an embodiment of the invention in a side view, showing an example of a user interface.

FIG. 16A-B are schematic illustrations, in an out of scale manner of different embodiments of the invention comprising a first inflatable membrane for providing alternating pressure, a second inflatable membrane providing ear canal sealing and pressure control, and oscillating vibration providing means.

FIG. 17 is a schematic illustration, in an out of scale manner of an embodiment of the invention comprising a remote control system.

### DETAILED DESCRIPTION OF THE PREFERRED EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

The essence of the present invention is to provide an ear therapeutic device intended for relieving pain and/or discomfort of the ear by balancing pressure in the middle ear. This is achieved by delivering pneumatic pressure and/or oscillating vibrations via the ear canal, the nasal cavity, and/or other head tissue, relieving positive/negative ear pressure and assisting in fluid drainage during its operation and methods thereof.

The term “ear piece” interchangeably refers hereinafter to any member, part, or portion of the ear device of the present invention that is configured to at least partially interface with at least a portion of the patient's ear. The ear piece can be as such as an earphone, ear cover, ear insert, ear muff and etc. Further the ear piece can be at least partially inserted into the ear, at least partially on the ear, at least partially around the ear, at least partially hanging on at least a portion of the ear, supported by a head/neck/shoulder connecting support (such as a bow, elastic strap, sticker, band, rigid support, and etc.), and any combination thereof. Additionally or alternatively, the ear piece is configured to at least partially block or seal the ear external canal while allowing the passage of pneumatic pressure in the form of movement of air, an inflated balloon and/or expandable membrane. Additionally or alternatively, at least a portion of the ear piece is comprised of sterilizable material, or disposable material, and may be reversibly attachable and detachable from the device. Additionally or alternatively, at least a portion of the ear piece is made of materials comfortable to ware such as padded elements, rubber elements and etc. Additionally or alternatively, the ear piece further comprises at least one portion configure to be at least partially inserted into the external ear canal and optionally at least one adjustable portion fitting to the outer ear.

The term “mouth piece” or “mouthpiece” interchangeably refers hereinafter to a part of the device of the present invention which comes near or in contact with one's mouth during use. The mouthpiece can be of various embodiments, such as, as non-limiting examples: a simple opening that leads to the main body of the device of the present invention, a mouth piece comprising at least a portion partially protruding configured to be at least partially insertable into a user's mouth, a mouthpiece is a part having at least a portion thereof configured to be at least partially gripped by the user grips in his/her mouth, a mouthpiece comprising an outer rubber flange that fits outside the lips having a mouth mask like formation, and any combination thereof.

The term “nose piece” interchangeably refers herein to any device configured to at least partially seal at least a portion of the patient nasal cavity and allow administration of pneumatic pressure thereto. Additionally or alternatively the nose piece is such as a mask around the nose, on the nose, at least partially insertable to at least one nostril, and any combination thereof. It is in the scope of the invention to provide pneumatic pressure to the patient nasal cavity thereby assisting in closure of the patient soft palate.

The term “flexible material” interchangeably refers hereinafter to any material capable of bending easily without breaking, or that is able to be easily modified to respond to altered circumstances or conditions. This can be as a none-limiting example: rubber, synthetic rubber, silicon, polyamides, nylon, textile, cloth, plastic, polyester, polyethylene, polyvinyl chloride (PVC), low-density polyethylene (LDPE), polypropylene, polyurethanes, polysulfone, and any composite materials of the any of the above.

The term “vibration means” refers hereinafter to any device, apparatus, instrument assembly, able to produce artificially induced vibrations, harmonic or none harmonic. As a none-limiting example, this can be such as a vibrator, eccentric weights, vibration piston, acoustic generator, servohydraulic (electrohydraulic) shakers, electrodynamic shakers, and etc. The vibrations improve mucociliary clearance of secretions in Eustachian tube and airways, thus preventing accumulation of secretions and diseases.

The term “pressure means” interchangeably refers hereinafter to any pressure equalizing means, including pneumatic pressure application by such as: a user's air blowing, a pneumatic pump, bellow, piston, an electrical pneumatic pump, a manual pump, an air compressor, ventilator, fan, flexible bag, and etc. The pressure applied by the system can be positive, negative or both. Negative pressure can be achieved by vacuum producing means. Pressure producing means can be covered by an inflatable/deflatable balloon or flexible membrane which provides a selectable overall or basal pressure.

The term “data logger” interchangeably refers hereinafter to any instrument having a vibration/pressure sensor and a digital memory, able to measure, record and store autonomously shocks, vibrations, or pressure over a defined period of time. Digital data is usually in the form of acceleration, amplitude and time. The data can be retrieved, viewed and evaluated after it has been recorded.

The term “external environment” refers hereinafter to the external space outside of the patient's body.

The term “about” refers hereinafter to 20% more or less than the defied value.

The term “patient” interchangeably refers herein after to a term selected from a group of: neonate, baby, infant, toddler, child, adolescent, adult, elderly, etc.; further this term refers to person or animal.

The term “user” interchangeably refers herein to any person operating the ear therapeutic device. This can be either the patient, or any care taker.

The term “transparent material” interchangeably refers hereinafter to materials such as, poly-methyl methacrylate, thermoplastic polyurethane, polyethylene, polyethylene terephthalate, isophthalic acid modified polyethylene terephthalate, glycol modified polyethylene terephthalate, polypropylene, polystyrene, acrylic, polyacetate, cellulose acetate, polycarbonate, nylon, glass, polyvinyl chloride, etc. Further in some embodiments at least a portion of this material is imbedded with non-transparent materials for means of strength and/or conductivity such as metallic wires.

The term “conduit” interchangeably refers to any at least partially hollow construct configured to allow fluid communication therethrough. This can be such as tube, channel, canal, hose, line, duct, pipe, cable, vein, route, aisle, aqueduct and etc. additionally or alternatively, at least a portion of the conduit is made of flexible material, rigid material or both. Additionally or alternatively, the conduit comprises one or more openings. Additionally or alternatively the conduit is branched into two or more conduits.

The term “patient's monitoring sensor” interchangeably refers to any sensor monitoring the physical condition of the patient. The sensor can be, as a none-limiting example, a cardio vascular sensor, a breathing sensor, a pressure sensor in the ear, a temperature sensor, a movement sensor, a liquid sensor for the middle ear, and etc.

It is in the scope of the present invention to provide “protocols” and “sub protocols” that include vibration producing oscillations, pneumatic pressure, or both, administered individually or simultaneously. The protocols are comprised of any combination of the mentioned sub protocols.

Both the vibrations and pneumatic pressure are administered with sup protocols including constant administration, intermittent, pulsating, or any combination thereof.

Sub protocols for providing different pressures having at least one variable parameter such as amplitude, duration of velocity of pressure incline or decline, pulsating or constant, frequency of pulsation, wave length, and different wave forms. It is in the scope of the present invention to provide a pressure wave that of a form such as sinusoid, triangular, rectangular, trapezoid, linear, curved, arched, or any other wave form symmetric or non-symmetric. Additionally or alternatively, the wave is pulsating, and/or pulsating in an attenuated, intensified and any combination thereof, manner. Additionally or alternatively, the administered pressure is positive, negative or a combination sequence of both.

Sub protocols providing different vibrations include administering vibrations such as:

Vibration from one or more vibration means, applying vibrations to one or more locations, individually or simultaneously. The vibrations can be humming vibrations, oscillating vibrations, acoustical originating vibrations, mechanical originating vibrations, and etc.

A plurality of vibrations can be administered in the sub protocols comprising at least one variable parameter such as waveform, duration, wave length, frequency, amplitude, velocity, direction, and any combination thereof. It is in the scope of the present invention to provide a vibration wave that of a form such as sinusoid, triangular, rectangular, trapezoid, linear, or any other wave form symmetric or non-symmetric. Additionally or alternatively, the wave is pulsating, and/or pulsating in an attenuated, intensified and any combination thereof, manner.

There may be more than one effector, for example, for producing vibrations within a particular range of amplitudes and frequencies, whereas other effectors may be adapted to produce vibrations within other ranges of amplitudes and frequencies. The mechanical vibrations provided may be applied directly to the patient's affected part, or they may be transmitted through inflated balloons, pads or cushions.

Sub protocols providing different pressure durations, and different protocol durations

It is in the scope of the present invention to provide “protocols” and “sub protocols” defined by a medical care taker or doctor, predefined by the manufacturer, manually configured by the user/patient, or providing personalized treatment of the patient, according to his/her specific needs. These can be tailored individually to each patient.

It is in the scope of the present invention to provide the device as defined above, wherein the protocols include silent periods and active periods as herein described.

Other optional elements may be provided, including: heating elements, and fluid perfusion or medicated fluid administration means.

The term “visual indicators” interchangeably refers hereinafter to a representation of light in the visible light range of about 380 nanometers to about 740 nm. More generally the terms refer to any light within the visible range that will be noticeable by the user of the invention (light, flashing light, flickering light, blinking light, change of spectrum of colors of light etc.).

The term “audible indicators” interchangeably refers hereinafter to a representation of sound, typically as an electrical voltage. Audible indicators have frequencies in the audio frequency range of roughly 20 to 20,000 Hz (the limits of human hearing). Audible indicators are either synthesized directly, or originate at a transducer such as a microphone, musical instrument pickup, phonograph cartridge, or tape head.

The term “sensible indicators” interchangeably refers hereinafter to a physical movement of at least a portion of the user interface, which is noticeable to the user (shaking, vibrating, quivering, etc.).

The term “connected” in reference to the ear therapeutic device, and ear therapeutic device parts and modules, interchangeably refers hereinafter to any contact, relation, association, integration, interconnection, joining, inserting, sewing, welding, interweaving, placing, nesting, layering, etc., of the ear device parts to each other and to a third party.

The term “plurality” interchangeably refers hereinafter to an integer α, when α>1.

The term “manual” in respect to the ear therapeutic device interchangeably refers herein after to any application of force by the handler aimed at moving at least a portion of the device. This force is generated by an action such as pushing, pulling, lifting, levering, turning, twisting, hitting, lowering, air blowing, inhaling, exhaling, pressing, tilting and etc.

The term “emergency release mechanism”, interchangeably refers hereinafter to a mechanism used in immediate need arrest of the device. This could be in case of malfunction, fire, excess heating, patient discomfort, patient trauma or medical condition, technical difficulty and etc. The emergency release can be operated manually by the patient or care taker, or by a predefined set of terms, such as: the temperature sensed by an attached temperature sensor exceeds a predefined valve, the pressure sensed by a pressure sensor exceeds a predefined value. Medical sensors monitoring the physical conditions of the patient at below or above a predefined range, and etc.

The term “Computer Readable Media”, (CRM), interchangeably refers hereinafter to, a medium capable of storing data in a format readable by a mechanical device (automated data medium rather than human readable). Examples of machine-readable media include magnetic media such as magnetic disks, cards, tapes, and drums, punched cards and paper tapes, optical disks, barcodes and magnetic ink characters. Common machine-readable technologies include magnetic recording, processing waveforms, and barcodes. Optical character recognition (OCR) can be used to enable machines to read information available to humans. Any information retrievable by any form of energy can be machine-readable.

According to one embodiment of the present invention, an ear therapeutic device (ETD), useful for providing artificially induced vibrations, pneumatic pressure, or both, to at least a portion of a patient's ear, comprising: (a) middle ear ambient pressure equalizing means; (b) one or more vibrations means for providing oscillating vibrations to at least a portion of the patients head; wherein middle ear pressure equalizing means comprises at least one conduit comprising at least one first end configured for external attachment to the mouth aperture and at least one second end configured for external attachment to the ear aperture, the conduit configured to permit fluid communication therebetween and the vibration means is configured to propagate artificially induced vibrations along the conduit and into the patient Eustachian tube.

According to one embodiment of the invention an ear therapeutic device (ETD), useful for providing artificially induced vibrations, pneumatic pressure, or both, to at least a portion of a patient's ear, comprising: (a) middle ear ambient pressure equalizing means; (b) one or more vibrations means for providing oscillating vibrations to at least a portion of the patients head; wherein middle ear pressure equalizing means comprises at least one conduit comprising at least one first end configured for external attachment to at least pressure equalizing means and at least one second end configured for external attachment to the ear aperture, the conduit configured to permit fluid communication therebetween, and the vibration means is configured to propagate artificially induced vibrations along the conduit and into the patient Eustachian tube.

According to another embodiment of the invention, an ETD as defined above is disclosed, wherein the ETD is configured to provide one or more protocols comprising administration of a selected from a group consisting of: the oscillating vibrations by one or more vibrations means, pressure by at one or more the pressure equalizing means, and any combination thereof.

According to another embodiment of the invention, an ETD as defined above is disclosed, wherein the one or more protocols comprises at least one sub protocol.

According to another embodiment of the invention, an ETD as defined above is disclosed, wherein the sub protocols comprise vibration producing oscillations, pneumatic pressure, or both, administered individually or simultaneously.

According to another embodiment of the invention, an ETD as defined above is disclosed, wherein one or more the sub protocol further comprising administration of the vibrations, the pressure, or both, in a manner selected from a group consisting of: constant, intermittent, pulsating, arbitrary, or any combination thereof.

According to another embodiment of the invention, an ETD as defined above is disclosed, wherein one or more the sub protocol further provides administration of the pressure, the vibrations, or both, comprising at least one variable parameter selected from a group consisting of: amplitude, velocity, frequency, wave length, wave forms, duration, direction, and any combination thereof.

According to another embodiment of the invention, an ETD as defined above is disclosed, wherein at least one of the wave forms is selected from a group consisting of: sine wave, linear wave, curved wave, triangular wave, rectangular wave, square wave, saw-tooth wave, trapezoid wave, and any combination thereof.

According to another embodiment of the invention, an ETD as defined above is disclosed, wherein the wave comprises at least one component selected from a group consisting of: harmonic frequencies, non-harmonic frequencies, acoustic waves, non-acoustic waves, and any combination thereof.

According to another embodiment of the invention, an ETD as defined above is disclosed, wherein the pressure provided by one or more the sub protocol is positive pressure, negative pressure or a combination sequence of both.

According to another embodiment of the invention, an ETD as defined above is disclosed, wherein one or more the sub protocol further comprising administration of a plurality of the vibrations by one or more the vibration means, such that each vibration differs by at least one parameter selected from a group consisting of: amplitude, velocity, frequency, wave length, wave forms, duration, direction, and any combination thereof.

According to another embodiment of the invention, an ETD as defined above is disclosed, wherein one or more the sub protocol further comprising administration of a plurality of the pressure by one or more the pressure equalizing means, such that each administered pressure differs by at least one parameter selected from a group consisting of: amplitude, velocity, frequency, wave length, wave forms, duration, direction, and any combination thereof.

According to another embodiment of the invention, an ETD as defined above is disclosed, wherein the protocols, sub protocols or both are selected from a group consisting of: defined by medical care, predefined by the manufacturer, manually configured by the user, and any combination thereof.

According to another embodiment of the invention, an ETD as defined above is disclosed, wherein the ETD further comprises at least one patient interfacing piece configured to be reversibly attached to at least a portion of a patient's organ selected from a group consisting of: nose, nasal bridge, nostril, ear, ear canal, cheek, forehead, temple, neck, inner throat, head, mouth, philtrum, glabella, nasion, chin, face, jaw, and any combination thereof.

According to another embodiment of the invention, an ETD as defined above is disclosed, wherein the patient interfacing piece comprises at least one aperture, configured to permit fluid communication therethrough.

According to another embodiment of the invention, an ETD as defined above is disclosed, wherein the patient interfacing piece is configured to at least partially seal a patient's aperture selected from a group consisting of: mouth, at least one nostril, external auditory ear canal, ear, nose, and any combination thereof from fluid communication with the external air.

According to another embodiment of the invention, an ETD as defined above is disclosed, wherein the device further comprises at least one element, connected to at least one conduit end, selected from a group consisting of: (a) a mouth piece (110) configured to permit fluid communication from the patient's or user's mouth to the conduit; (b) an ear piece (122, 120, 125) configured to at least partially seal the patient's ear canal from air external to the conduit and permit fluid communication from the conduit to the patient's ear; (c) a connection to an external pneumatic pressure means selected from a group consisting of: a pneumatic compressor, a manual pump, an automatic pump, an air blower, vacuum, bellow, piston, flexible bag, and any combination thereof; (d) a nose piece (200) configured to permit fluid communication into and out of the patient's nose and through the conduit; (e) a reversibly attachable facial mask (130) configured to at least partially seal at least a portion of the patient face from external air, configured to permit fluid communication to at least a portion of the patients face from the conduit; and any combination thereof.

According to another embodiment of the invention, an ETD as defined above is disclosed, wherein the conduit further comprises at least one turnable hinge (68), such that the orientation of a selected from a group consisting of: the mouth piece, the ear piece, the nose piece, the facial mask, and any combination thereof, is adjustable.

According to another embodiment of the invention, an ETD as defined above is disclosed, wherein at least a portion of the conduit is made of a selected from a group consisting of: flexible material, at least partially transparent material, sterilizable material, disposable material, and any combination thereof.

According to another embodiment of the invention, an ETD as defined above is disclosed, wherein the fluid communication is configured to be bi-directional, unidirectional, or both.

According to another embodiment of the invention, an ETD as defined above is disclosed, wherein the ETD further comprises at least one valve configured to regulate the pressure administered by the pressure equalizing means.

According to another embodiment of the invention, an ETD as defined above is disclosed, wherein one or more the valve is selected from a group consisting of: a pressure tuning valve, a pressure release valve, a pressure buildup valve, and any combination thereof.

According to another embodiment of the invention, an ETD as defined above is disclosed, wherein one or more valve is operated in a manner selected from a group consisting of: by an operating system, automatically according to predefined parameters, manually, and any combination thereof.

According to another embodiment of the invention, an ETD as defined above is disclosed, wherein the conduit comprises at least one pressure regulating valve operative by the patient inhaling, exhaling, or both.

According to another embodiment of the invention, an ETD as defined above is disclosed, wherein the conduit comprises at least on/off switch configured to be controlled by the patient inhaling, exhaling or both.

According to another embodiment of the invention, an ETD as defined above is disclosed, wherein the ETD is configured to be controlled by a selected from a group consisting of: a remote control, a remote computer, a cellular phone, a PDA, a tablet, cloud computing, remote server, and any combination thereof.

According to another embodiment of the invention, an ETD as defined above is disclosed, wherein the device further comprises at least one operating system configured to control a selected from a group consisting of: one or more the vibration means, one or more the pressure equalizing means, one or more the valves, and any combination thereof.

According to another embodiment of the invention, an ETD as defined above is disclosed, wherein the operating system is configured to control the vibration parameter selected from a group consisting of: amplitude, frequency, duration, velocity, wavelength, waveform, and any combination thereof.

According to another embodiment of the invention, an ETD as defined above is disclosed, wherein the device comprises at least one first vibration means and at least one second vibration means, further wherein the control system is configured to control each vibration means independently.

According to another embodiment of the invention, an ETD as defined above is disclosed, wherein at least one first the vibration means and at least one second the vibration means are configured to operate at least partially simultaneously thereby administering wave interference vibrations to the patient.

According to another embodiment of the invention, an ETD as defined above is disclosed, wherein at least one first vibration means and at least one second vibration means are configured to operate provide each a different vector vibration.

According to another embodiment of the invention, an ETD as defined above is disclosed, wherein the operating system is configured to provide vibration, pneumatic pressure, or both by controlling at least one vibration means, pressure means or both.

According to another embodiment of the invention, an ETD as defined above is disclosed, wherein the operating system comprises at least one user interface.

According to another embodiment of the invention, an ETD as defined above is disclosed, wherein the operating system is controlled manually, automatically, or both.

According to another embodiment of the invention, an ETD as defined above is disclosed, wherein the operating system is controlled by a selected from a group consisting of: the patient's breathing, the patient's exhaling, the patients inhaling, the patient forcibly blowing air, voice activation, hand operation, and any combination thereof.

According to another embodiment of the invention, an ETD as defined above is disclosed, wherein the vibration means is configured to provide vibrations at a set of frequencies ranging from about 0.1 Hz to about 20 KHz.

According to another embodiment of the invention, an ETD as defined above is disclosed, wherein the vibration means is configured to provide vibration of at least one frequency in a value ranging from about 0.1 Hz to about 20 KHz.

According to another embodiment of the invention, an ETD as defined above is disclosed, wherein the vibration means are selected from a group consisting of: at last one vibrator, at least one acoustic generator, at least one eccentric weight, at least one piston, at least one shaker, and any combination thereof.

According to another embodiment of the invention, an ETD as defined above is disclosed, wherein the vibration means are configured to provide vibrations in interval frequencies of 0.5 Hz.

According to another embodiment of the invention, an ETD as defined above is disclosed, wherein the pressure means are configured to provide pressure ranging from about (−) 100 cmH₂O to about (+) 100 cmH₂O.

According to another embodiment of the invention, an ETD as defined above is disclosed, wherein the ETD comprises at least one sensor selected from a group consisting of: a patient monitoring sensor, a pressure sensor, a vibration sensor, and any combination thereof.

According to another embodiment of the invention, an ETD as defined above is disclosed, wherein the patient monitoring sensor is selected from a group consisting of: an ear drum pressure sensor, a tissue vibration sensor, a breathing sensor, a cardiovascular sensor, a pressure sensor, and any combination thereof.

According to another embodiment of the invention, an ETD as defined above is disclosed, wherein the sensor is configured to relay sensed information to at least one indicator selected from a group consisting of: auditable, sensible, visual, and any combination thereof.

According to another embodiment of the invention, an ETD as defined above is disclosed, wherein the sensor is configured to relay sensed information to the operating system.

According to another embodiment of the invention, an ETD as defined above is disclosed, wherein the one or more pressure equalizing means is configured to provide positive pressure, negative pressure, or both.

According to another embodiment of the invention, an ETD as defined above is disclosed, wherein the pressure equalizing means is selected from a group consisting of: at least one automatic air pump, at least one manual pneumatic pump, a vent, at least one air blowing device, the patient's inhaling/exhaling, the patient respiratory system, piston, bellow, flexible bag, and any combination thereof.

According to another embodiment of the invention, an ETD as defined above is disclosed, wherein the ETD further comprises at least one data logger.

According to another embodiment of the invention, an ETD as defined above is disclosed, wherein the device further comprises at least one processor in communication with a computer readable medium (CRM); the processor executes a set of operations received from the CRM; the set of operations are (a) receiving a treatment protocol; and, (b) operating a selected from a group consisting of: the pressure equalizing means, the vibration means, at least one valve, and any combination thereof according to the treatment protocol.

According to another embodiment of the invention, an ETD as defined above is disclosed, wherein the device further executes the following set of operations: (a) receiving information values relayed by at least one sensor; (b) comparing the information values relayed by at least one sensor to the operated treatment protocol values; and, (c) if information relayed by at least one sensor is different than information values of the treatment protocol, adjusting the values operated by a selected from a groups consisting of: the pressure equalizing means, the vibration means, at least one valve, and any combination thereof.

According to another embodiment of the invention, an ETD as defined above is disclosed, wherein the device further comprises wireless communication means, wired communication means or both.

According to another embodiment of the invention, an ETD as defined above is disclosed, wherein the wireless communication means are selected from a group consisting of: receiver, transmitter, transceiver, blue tooth system, cellular phone, Wi-Fi system, and any combination thereof.

According to another embodiment of the invention, an ETD as defined above is disclosed, wherein the device further comprises at least one emergency shutoff mechanism.

According to another embodiment of the invention, an ETD as defined above is disclosed, wherein the emergency mechanism is configured to stop the vibration, air pressure or both when detecting at least one of the following: (a) the pressure equalizing means providing pressure higher or lower than a predefined value range; (b) the vibration means providing vibration having a parameter selected from a group consisting of: frequency, duration, amplitude, waveform, wavelength, and any combination thereof, is of a value lower or higher than a predefined value range; and, (c) at least one sensor is sensing a value lower or higher than a predefined value range.

According to one embodiment of the invention, a method for equalizing ear pressure, wherein the method comprising steps of: (a) obtaining an ear therapeutic device (ETD) (100), useful for providing artificially induced vibrations, pneumatic pressure, or both, to at least a portion of a patient's ear, comprising: (i) middle ear ambient pressure equalizing means (500); (ii) at least one conduit (300) comprising at least one first end (127) configured for external attachment to the mouth aperture and at least one second end (126) configured for external attachment to the ear aperture, the conduit configured to permit fluid communication therebetween; (iii) one or more vibrations means (400) for providing oscillating vibrations to at least a portion of the patients head; (b) reversibly attaching at least a portion of one end to at least a portion of the patient's mouth and at least a portion of the second end to at least a portion of the patient's ear; and, (c) administering at least one of: (i) exhaling into the conduit through at least one first the conduit end (127), thereby administering equalizing pressure to the patient' ear; and, (ii) operating at least one vibration means (400) for administering oscillating vibration, thereby propagating artificially induced vibrations along the conduit and into the patient Eustachian tube (1000).

According to one embodiment of the invention, a method for equalizing ear pressure, wherein the method comprising steps of: (a) obtaining an ear therapeutic device (ETD) (100), useful for providing artificially induced vibrations, pneumatic pressure, or both, to at least a portion of a patient's ear, comprising: (i) middle ear ambient pressure equalizing means (500); (ii) at least one conduit (300) comprising at least one first end (127) configured for external attachment to at least one pressure equalizing means and at least one second end (126) configured for external attachment to the ear aperture, the conduit (300) configured to permit fluid communication therebetween; (iii) one or more vibrations means (400) for providing oscillating vibrations to at least a portion of the patients head; (b) reversibly attaching at least a portion of one end (126) to at least a portion of the patient's ear; and, (c) administering at least one of: (i) administering pneumatic pressure by at least one pressure equalizing device through at least one first the conduit end (127), thereby administering equalizing pressure to the patient' ear; (ii) operating at least one vibration means (400) for administering oscillating vibration, thereby propagating artificially induced vibrations along the conduit and into the patient Eustachian tube (1000).

According to one embodiment of the invention, a method for equalizing ear pressure, wherein the method comprising steps of: (a) obtaining an ear therapeutic device (ETD) (1000), useful for providing pneumatic pressure, to at least a portion of a patient's ear, comprising: (i) middle ear ambient pressure equalizing means (500), (ii) at least one conduit (300) comprising at least one first end (110) configured for external attachment to at least one pressure equalizing means and at least one second end (126) configured for external attachment to the ear aperture, the conduit (300) configured to permit fluid communication therebetween; (b) reversibly attaching at least a portion of one end (126) to at least a portion of the patient's ear; and, (c) exhaling into the conduit (300) through at least one first the conduit end (110), thereby administering equalizing pressure to the patient' ear.

According to another embodiment of the invention, a method as defined above is disclosed, additionally comprising the step of providing the ETD comprising at least one vibration means for administering oscillating vibration, and administering oscillating vibrations, thereby propagating artificially induced vibrations along the conduit and into the patient Eustachian tube;

According to another embodiment of the invention, a method as defined above is disclosed, additionally comprising the step of configuring the ETD to providing one or more protocols comprising administering a selected from a group consisting of: the oscillating vibrations by one or more vibrations means, pressure by at one or more the pressure equalizing means, and any combination thereof.

According to another embodiment of the invention, a method as defined above is disclosed, additionally comprising the step of administering the one or more protocols comprising at least one sub protocol.

According to another embodiment of the invention, a method as defined above is disclosed, additionally comprising the step of providing the sub protocols comprising vibration producing oscillations, pneumatic pressure, or both, and administering the sub protocols individually or simultaneously.

According to another embodiment of the invention, a method as defined above is disclosed, additionally comprising the step of providing one or more the sub protocol further comprising administering the vibrations, the pressure, or both, in a manner selected from a group consisting of: constant, intermittent, pulsating, arbitrary, or any combination thereof.

According to another embodiment of the invention, a method as defined above is disclosed, additionally comprising the step of providing one or more the sub protocol administering the pressure, the vibrations, or both, comprising at least one variable parameter selected from a group consisting of: amplitude, velocity, frequency, wave length, wave forms, duration, direction, and any combination thereof.

According to another embodiment of the invention, a method as defined above is disclosed, additionally comprising the step of providing at least one wave form selected from a group consisting of: sine wave, linear wave, curved wave, triangular wave, rectangular wave, square wave, saw-tooth wave, trapezoid wave, and any combination thereof.

According to another embodiment of the invention, a method as defined above is disclosed, additionally comprising the step of providing the wave comprising at least one component selected from a group consisting of: harmonic frequencies, non-harmonic frequencies, acoustic waves, non-acoustic waves, and any combination thereof.

According to another embodiment of the invention, a method as defined above is disclosed, additionally comprising the step of providing one or more the sub protocol administering positive pressure, negative pressure or a combination sequence of both.

According to another embodiment of the invention, a method as defined above is disclosed, additionally comprising the step of providing one or more the sub protocol further comprising administering a plurality of the vibrations by one or more the vibration means, such that each vibration differs by at least one parameter selected from a group consisting of: amplitude, velocity, frequency, wave length, wave forms, duration, direction, and any combination thereof.

According to another embodiment of the invention, a method as defined above is disclosed, additionally comprising the step of providing one or more the sub protocol further comprising administering a plurality of the pressure by one or more the pressure equalizing means, such that each administered pressure differs by at least one parameter selected from a group consisting of: amplitude, velocity, frequency, wave length, wave forms, duration, direction, and any combination thereof.

According to another embodiment of the invention, a method as defined above is disclosed, additionally comprising the step of selecting the protocols, sub protocols or both from a group consisting of: defined by medical care, predefined by the manufacturer, manually configured by the user, and any combination thereof.

According to another embodiment of the invention, a method as defined above is disclosed, additionally comprising the step of providing the ETD further comprising at least one patient interfacing piece configured to be reversibly attached to at least a portion of a patient's organ selected from a group consisting of: nose, nasal bridge, nostril, ear, ear canal, cheek, forehead, temple, neck, inner throat, head, mouth, philtrum, glabella, nasion, chin, face, jaw, and any combination thereof.

According to another embodiment of the invention, a method as defined above is disclosed, additionally comprising the step of providing the patient interfacing piece comprising at least one aperture, configured to permit fluid communication therethrough, and administrating fluid communication therethrough by at least one pressure equalizing means.

According to another embodiment of the invention, a method as defined above is disclosed, additionally comprising the step of providing the patient interfacing piece configured to at least partially seal a patient's aperture selected from a group consisting of: mouth, at least one nostril, external auditory ear canal, ear, nose, and any combination thereof from fluid communication with the external air, and at least partially sealing the patient aperture.

According to another embodiment of the invention, a method as defined above is disclosed, additionally comprising the step of providing the ETD further comprising at least one element, reversibly connected to at least one conduit end, selected from a group consisting of: (a) a mouth piece configured to permit fluid communication from the patient's or user's mouth to the conduit; (b) an ear piece configured to at least partially seal the patient's ear canal from air external to the conduit and permit fluid communication from the conduit aperture to the patient's ear; (c) a connection to an external pneumatic pressure means selected from a group consisting of: a pneumatic compressor, a manual pump, an automatic pump, an air blower, vacuum, and any combination thereof; (d) a nose piece configured to permit fluid communication into and out of the patient's nose and through the conduit; (e) an attachable facial mask configured to at least partially seal at least a portion of the patient face from external air, configured to permit fluid communication to at least a portion of the patients face from the conduit; and any combination thereof; and, reversibly attaching the element to the conduit end.

According to another embodiment of the invention, a method as defined above is disclosed, additionally comprising the steps of: (a) providing the ETD further comprising at least one mouth piece, connected to the one first conduit end configured to permit the passage of air from the patient's mouth to at least one second aperture, at least one second conduit end further comprising at least one ear piece configured to at least partially seal the ear canal from air, and permit the passage of pneumatic pressure from the conduit aperture to the patient's ear canal; (b) attaching at least a portion of the mouth piece to the patient's/user's mouth, and at least a portion of the ear piece to the patient ear; and, (c) administering equalizing pressure by inhaling, exhaling, or both into the mouth piece.

According to another embodiment of the invention, a method as defined above is disclosed, additionally comprising the step of providing the conduit further comprising at least one turnable hinge, and turning the hinge, thereby changing the orientation of a selected from a group consisting of: the mouth piece, the ear piece, the nose piece, the facial mask, and any combination thereof.

According to another embodiment of the invention, a method as defined above is disclosed, additionally comprising the step of providing at least a portion of the conduit made of a selected from a group consisting of: flexible material, at least partially transparent material, sterilizable material, disposable material, and any combination thereof.

According to another embodiment of the invention, a method as defined above is disclosed, additionally comprising the step of configuring the fluid communication to be bi-directional, unidirectional, or both.

According to another embodiment of the invention, a method as defined above is disclosed, additionally comprising the step of providing the ETD further comprising at least one valve, and configuring the valve to regulate the pressure administered by the pressure equalizing means.

According to another embodiment of the invention, a method as defined above is disclosed, additionally comprising the step of regulating the pressure administered by the pressure equalizing means by at least one valve.

According to another embodiment of the invention, a method as defined above is disclosed, additionally comprising the step of selecting one or more the valve from a group consisting of: a pressure tuning valve, a pressure release valve, a pressure buildup valve, and any combination thereof.

According to another embodiment of the invention, a method as defined above is disclosed, additionally comprising the step of operating one or more valve in a manner selected from a group consisting of: by an operating system, automatically according to predefined parameters, manually, by a user's respiratory system, and any combination thereof.

According to another embodiment of the invention, a method as defined above is disclosed, additionally comprising the step of operating one or more pressure equalizing means in a manner selected from a group consisting of: by an operating system, automatically according to predefined parameters, manually, by a user's respiratory system, and any combination thereof.

According to another embodiment of the invention, a method as defined above is disclosed, additionally comprising the step of operating at least one pressure regulating valve by the patient inhaling, exhaling, or both.

According to another embodiment of the invention, a method as defined above is disclosed, additionally comprising the step of operating at least one ETD on/off switch configured by the patient inhaling, exhaling or both.

According to another embodiment of the invention, a method as defined above is disclosed, additionally comprising the step of controlling the ETD by a selected from a group consisting of: a remote control, a remote computer, a cellular phone, a PDA, a tablet, cloud computing, remote server, and any combination thereof.

According to another embodiment of the invention, a method as defined above is disclosed, additionally comprising the step of providing the ETD further comprises at least one operating system configured to control a selected from a group consisting of: one or more the vibration means, one or more the pressure equalizing means, one or more the valves, and any combination thereof, and controlling the ETD by the operating system.

According to another embodiment of the invention, a method as defined above is disclosed, additionally comprising the step of configuring the operating system to control the vibration parameter selected from a group consisting of: amplitude, frequency, duration, velocity, wavelength, waveform, and any combination thereof, and controlling the parameter.

According to another embodiment of the invention, a method as defined above is disclosed, additionally comprising the step of providing the ETD comprising at least one first vibration means and at least one second vibration means, and controlling each vibration means independently, by the operating system.

According to another embodiment of the invention, a method as defined above is disclosed, additionally comprising the step of configuring at least one first the vibration means and at least one second the vibration means to operating at least partially simultaneously, thereby administering wave interference vibrations to the patient.

According to another embodiment of the invention, a method as defined above is disclosed, additionally comprising the step of configuring at least one first vibration means and at least one second vibration means to providing each a different vector vibration.

According to another embodiment of the invention, a method as defined above is disclosed, additionally comprising the step of the operating system is configured to provide vibration, pneumatic pressure, or both by controlling at least one vibration means, pressure means or both.

According to another embodiment of the invention, a method as defined above is disclosed, additionally comprising the step of controlling the operating system by at least one user interface.

According to another embodiment of the invention, a method as defined above is disclosed, additionally comprising the step of controlling the operating system manually, automatically, or both.

According to another embodiment of the invention, a method as defined above is disclosed, additionally comprising the step of controlling the operating system by a selected from a group consisting of: the patient's breathing, the patient's exhaling, the patients inhaling, the patient forcibly blowing air, voice activation, hand operation, and any combination thereof.

According to another embodiment of the invention, a method as defined above is disclosed, additionally comprising the step of administering vibrations by the vibration means at a set of frequencies, at least one frequency, or both, in a value ranging from about 0.1 Hz to about 20 KHz.

According to another embodiment of the invention, a method as defined above is disclosed, additionally comprising the step of providing the vibration means selected from a group consisting of: at last one vibrator, at least one acoustic generator, at least one eccentric weight, at least one piston, at least one shaker, and any combination thereof.

According to another embodiment of the invention, a method as defined above is disclosed, additionally comprising the step of the vibration means are configured to provide vibrations in interval frequencies of 0.5 Hz.

According to another embodiment of the invention, a method as defined above is disclosed, additionally comprising the step of the pressure means are configured to provide pressure ranging from about (−) 100 cmH₂O to about (+) 100 cmH₂O.

According to another embodiment of the invention, a method as defined above is disclosed, additionally comprising the step of providing the ETD further comprising at least one sensor selected from a group consisting of: a patient monitoring sensor, a pressure sensor, a vibration sensor, and any combination thereof.

According to another embodiment of the invention, a method as defined above is disclosed, additionally comprising the step of providing the patient monitoring sensor selected from a group consisting of: an ear drum pressure sensor, a tissue vibration sensor, a breathing sensor, a cardiovascular sensor, a pressure sensor, and any combination thereof.

According to another embodiment of the invention, a method as defined above is disclosed, additionally comprising the step of relaying information sensed by the sensor to at least one indicator selected from a group consisting of: auditable, sensible, visual, and any combination thereof.

According to another embodiment of the invention, a method as defined above is disclosed, additionally comprising the step of relaying information sensed by the sensor to the operating system.

According to another embodiment of the invention, a method as defined above is disclosed, additionally comprising the step of administering positive pressure, negative pressure, or both, by the one or more pressure equalizing means.

According to another embodiment of the invention, a method as defined above is disclosed, additionally comprising the step of providing the pressure equalizing means selected from a group consisting of: at least one automatic air pump, at least one manual pneumatic pump, a vent, at least one air blowing device, the patient's inhaling/exhaling, the patient respiratory system, bellow, piston, flexible bag, and any combination thereof.

According to another embodiment of the invention, a method as defined above is disclosed, additionally comprising the step of providing the ETD further comprising at least one data logger, and recording by the data logger data selected from a group consisting of: time of ETD operation, date of ETD operation, duration of ETD operation, protocol administered by the ETD, sub protocol administered by the ETD, configurations applied to ETD, configurations applied to at least one protocol, sub protocol or both, information sensed by at least one of the sensors, and any combination thereof.

According to another embodiment of the invention, a method as defined above is disclosed, additionally comprising the step of providing the ETD further comprising at least one processor in communication with a computer readable medium (CRM); the processor executes a set of operations received from the CRM; the set of operations are: (a) receiving a treatment protocol; (b) operating a selected from a group consisting of: the pressure equalizing means, the vibration means, at least one valve, and any combination thereof according to the treatment protocol; and, (c) executing the operations.

According to another embodiment of the invention, a method as defined above is disclosed, additionally comprising the steps of executing the following set of operations: (a) receiving information values relayed by at least one sensor; (b) comparing the information values relayed by at least one sensor to the operated treatment protocol values; and, (c) if information relayed by at least one sensor is different than information values of the treatment protocol, adjusting the values operated by a selected from a groups consisting of: the pressure equalizing means, the vibration means, at least one valve, and any combination thereof.

According to another embodiment of the invention, a method as defined above is disclosed, additionally comprising the step of providing the ETD further comprising wireless communication means, wired communication means or both.

According to another embodiment of the invention, a method as defined above is disclosed, additionally comprising the step of selecting the wireless communication means from a group consisting of: receiver, transmitter, transceiver, blue tooth system, cellular phone, Wi-Fi system, and any combination thereof.

According to another embodiment of the invention, a method as defined above is disclosed, additionally comprising the step of providing the ETD further comprising at least one emergency shutoff mechanism.

According to another embodiment of the invention, a method as defined above is disclosed, additionally comprising the step of configuring the emergency mechanism to stop the vibration, air pressure or both when detecting at least one of the following: (a) the pressure equalizing means providing pressure higher or lower than a predefined value range; (b) the vibration means providing vibration having a parameter selected from a group consisting of: frequency, duration, amplitude, waveform, wavelength, and any combination thereof, is of a value lower or higher than a predefined value range; and, (c) at least one sensor is sensing a value lower or higher than a predefined value range.

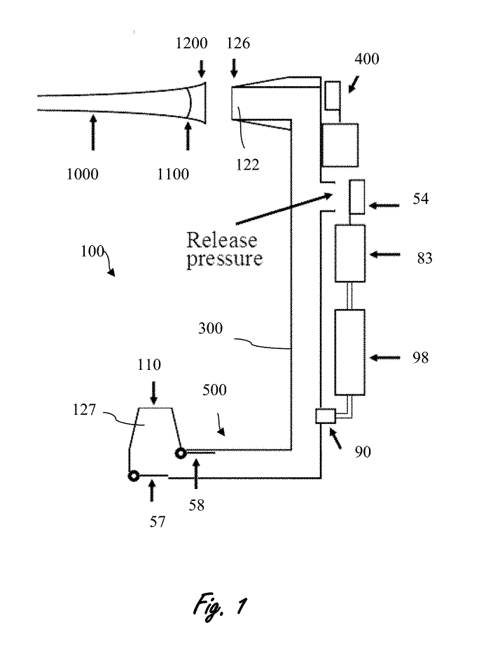

Reference is now made to FIG. 1 schematically illustrating, in an out of scale manner, an embodiment of the ear therapeutic device (100). Ear pressure equalizing means (500) comprising at least one conduit (300) having at least one first end attachable to the ear aperture (126), and at least one second end (127) connected to the mouth aperture. At least one first conduit end comprises an ear piece (122), and at least one second ear piece is connected to a mouth piece (110). The conduit (300) is configured to permit the passage of air from the mouth piece (110) to the ear piece (122). The ear piece is configured to at least partially seal the external ear canal (1200), while allowing pneumatic pressure to pass through enabling application of positive or negative pressure on the ear drum (1100). The conduit (300) is further connected to a controller (98) designed to control the pneumatic pressure applied by the device (100). The controller is further connected to a release valve motor (83) and at least one release valve (54) configured to allow pressure release and pressure buildup when opened or closed accordingly. The pressured is also monitored by at least one pressure sensor (90), relaying the sensed information to such as the controller, at least one indicator, or a CRM. The device further comprises at least one vibrator (400), configured to provide oscillating vibrations to the ear by the earphone. The vibrations can improve draining of fluids in the ear and the Eustachian tube (1000), promoting healing and/or pressure equalizing.

Additionally or alternatively the device can be operated by the patient inhaling, exhaling, forcibly blowing air, by remote control, by a wireless/wired connection to a remote computer, by the controller having a user interface including operational features such as buttons, knobs, sliders, touch screen, keyboard, voice activation, computer mouse, and etc. Additionally or alternatively, the device (100) is configured to operate by a providing a treatment protocol of vibrations and/or pneumatic pressure. The device (100) is configured to provide at least one protocol of administering at least one of the following: vibrations, positive pressure, and negative pressure. This administration is either simultaneously or intermittently or a combination of both. Additionally or alternatively the time duration of each protocol or sub protocol can be predefined, manually changed by the user, or both. Additionally or alternatively the specific treatment protocol can be predefined, manually adjusted by the user or both. Further, the unique combination of protocols and sub protocols can be predefined or manually adjusted according to such as the patient input, the directions of medical personal, and etc. Additionally or alternatively, a plurality of sub-protocols is provided comprising at least one set of vibrations, having differential wavelength, frequency, amplitude, velocity, duration, waveform, and any combination thereof. Any set of vibrations can be provided in combination with pneumatic pressure. The pneumatic pressure can be either uniform or variable, constant or intermitted and any combination thereof, and can also be administered in an oscillating wave formation. Additionally or alternatively, the pneumatic pressure is administered in a protocol comprising any combination of pneumatic pressure and vibration. Further, the vibration can be applied by one or more vibrators. When comprising a plurality of vibrators, the vectors of vibrations can be parallel, intersecting, unparalleled, divergent or similar. Additionally or alternatively, a sub-protocol is provided configured to administering vibrations from different at least partially intersecting vectors forming new combinations of vibrations due to wave interference.

The mouth piece is provided with at least one inhalation valve (57) and at least one exhalation valve (58). When inhaling, the inhalation valve (57) opens to allow the entry of external air through the mouthpiece into the patient's mouth, and close to prevent the escape of air, and consequence pressure decline when exhaling. In an embodiment, the exhalation valve remains closed such that mainly external air reaches the mouth piece. When exhaling the exhalation valve maneuvers to an open position allowing the air originating at the patient's mouth to pass towards the earphone.

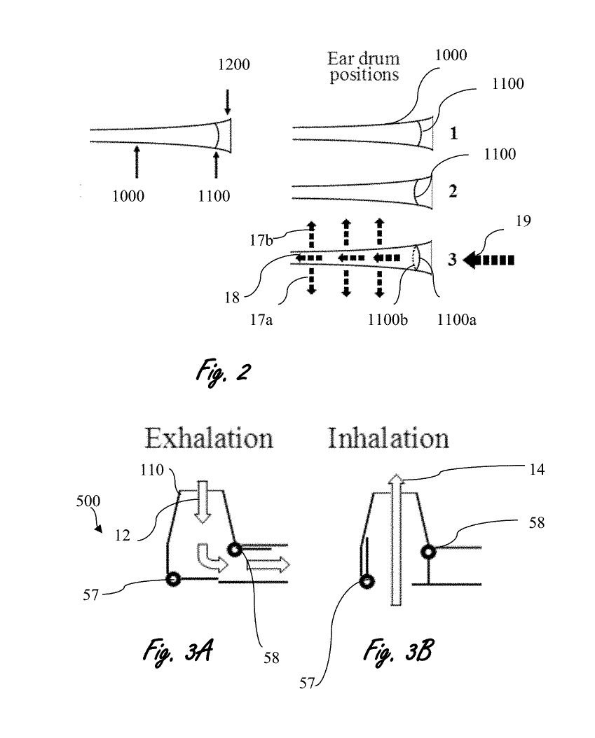

Reference is now made to FIG. 2, schematically illustrating, in an out of scale manner, various ear drum (1100) positions. A portion of the ear is schematically drawn to exemplify the Eustachian tube (1000), the ear drum (1100) and the external ear canal (1200). FIG. 2 (1) shows the position of the ear drum (1100) when internal positive pressure is applied forcing a protrusion of the eardrum towards the ear canal. FIG. 2 (2) shows another position of the ear drum when negative pressure is formed within the ear (positive pressure from the external ear canal) and as a result, the eardrum is protruding towards the inner ear.

Both these situations are associated with patient discomfort, and are usually equalized by temporarily opening of the Eustachian tube. When unable to do so due to for example a clog of the Eustachian tube (caused by such as cold, allergy, infection and etc.), the patient may experience dizziness, pain, hearing impairment, stuffiness. FIG. 2 (3) shows the direction of pressure and/or vibration application to the ear via the external ear canal affecting the ear drum to maneuver from formation 1100a to formation 1100b and the vibrations to travel along the Eustachian tube, as an none limiting example, in the direction indicated by the arrows (17a, 17b, 18).

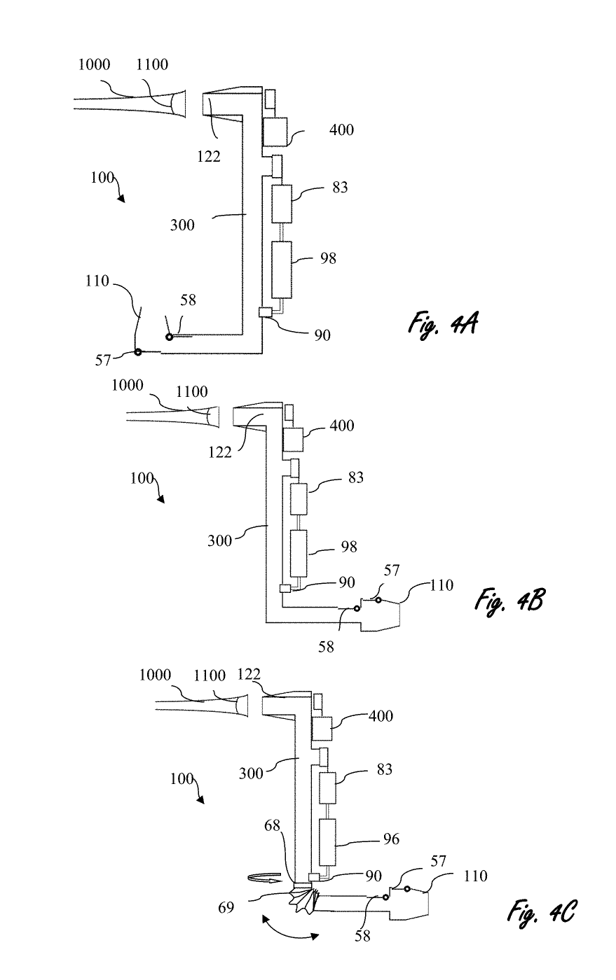

Reference is now made to FIG. 3A-B schematically illustrating, in an out of scale manner, embodiments of a mouth piece (110) of the invention. The mouth piece is provided with at least one inhalation valve (57) and at least one exhalation valve (58). FIG. 3B illustrates an example of the valves position when inhaling. When inhaling, the inhalation valve (57) opens to allow the entry of external air (14) through the mouthpiece into the patient's mouth, and close to prevent the escape of air, and consequence pressure decline when exhaling. In an embodiment, the exhalation valve (58) remains closed such that mainly external air reaches the mouth piece. FIG. 3A illustrates the position of the valves when exhaling. When exhaling the exhalation valve (58) maneuvers to an open position allowing the air originating at the patient's mouth to pass towards the earphone.

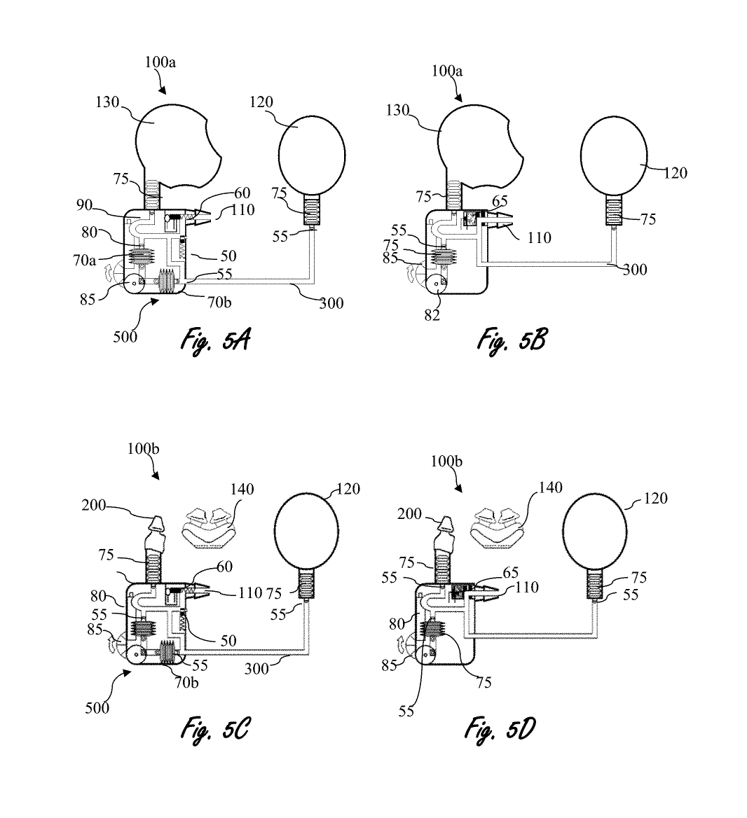

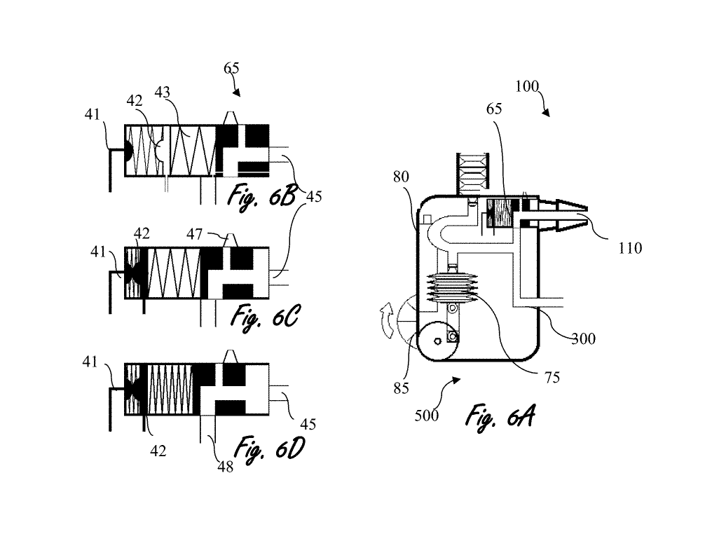

Reference is now made to FIG. 4A, schematically illustrating, in an out of scale manner of an embodiment of an ear therapeutic device (100) for self-use. In this embodiment, the conduit (300) is connected at one end to an ear piece/ear phone (122), and on the other end to a mouth piece (110). The ear piece (122) is protruding in a substantially perpendicular angle to the conduit, and the mouth piece is connected to a parallel protrusion at the opposite end. This embodiment enables the patient to use the device independently, unassisted. The device is configured such that when the ear piece (122) is at least partially interfacing with the patient's ear positioned towards the ear drum (1100) and the Eustachian canal (1000), the mouthpiece (110) reaches the patient's mouth. Additionally or alternatively, at least a portion of the conduit (300) is made from flexible materials enabling adjustments of the conduit such that the different parts and portions fit the patient. Additionally or alternatively, the conduit comprises at least a portion of a segmented structure. In this embodiment, at least one segment is reversibly connectable to said conduit, such that this segment can be exchangeable with different sized or shaped segment such that the device is fitted to be used by different sized individuals. Additionally or alternatively, a different sized and/or shaped segment is used for the optional connection of additional vibration means, pneumatic pressure means, heating means, and any combination thereof. The device comprises at least one vibrator (400), at least one controller (98) connected to a release valve motor (83), operative to release a valve (54) according to information received by a pressure sensor (90). The ear device further comprises at least one inhalation valve (57) and at least one exhalation valve (58).

Reference is now made to FIG. 4B schematically illustrating, in an out of scale manner, an embodiment of an ear therapeutic device for operation by a care taker. In this embodiment the protrusion connecting the conduit (300) to the mouth piece (110) extends to substantially the opposite direction than the one comprising the ear piece. In this manner, easy access is provided for a care taker to operate the mouth piece (110) while the ear piece (122) is interfacing the patient.

Reference is now made to FIG. 4C, schematically illustrating, in an out of scale manner, an embodiment of the ear therapeutic device having an adjustable flexible portion (69) and a turnable hinge (68). Additionally or alternatively, the device comprises a plurality of flexible portions and/or hinges. In this embodiment the device can be operated by either the patient and/or alternatively by a care taker. This, by adjusting the precise position and angle of different portions of the conduit utilizing the flexible portion and or one or more hinges.

Reference is now made to FIG. 5A-B, schematically illustrating, in an out of scale manner different embodiments of the invention, comprising a nose mask (130). FIG. 5A illustrates the ear therapeutic device (100a), comprising a conduit (300) embodied as a hollow tubing system configured to permit the passage of fluid within. In this embodiment, the pneumatic pressure is provided by at least one motor (80) operating a plurality of pressure providing means such as at least one pump, bellow, piston, (70a, 70b), included in the pressure equalizing means (500). The conduit comprises tubing connecting one pump (70a) to a nose mask (130) and another pump is connected to an ear cover (120). The pneumatic pressure provided by the pumps is controlled by at least one of the following: a motor velocity adjustor (85), enabling at turning up/down the velocity of the motor, thereby adjusting the pressure buildup and the pressure buildup speed; one or more valves (50) positioned along the conduit; additional pressure providing means such as a pump, piston, and/or bellow (75) connected in proximity to the nose mask (130) and or ear cover (120); additional valves (55) can be placed at the airways in the pump exits. Additionally or alternatively, one or more of the valves is such as a servo valve, predefined to close/open according to preset pressure values. Optionally, the valves are opened and/or closed in accordance to a treatment protocol or sub-protocol. In addition, the user can control at least one valve (50) manually. The device (100a) is configured to be operated by the user inhaling, exhaling, and/or air blowing into a mouth piece (110). In this embodiment the mouth piece is connected to an on/off button (60) and a pressure control valve (50) configured to respond to the user's exhaling, and/or air blowing. Additionally or alternatively, the device (100) is configured to administer pressure in the nasal pathways thereby assisting in closing of the soft palate. Reference is now made to FIG. 5B, schematically illustrating, in an out of scale manner, an embodiment of the ear therapeutic device comprising one pneumatic pump in fluid communication with both the nose mask (130) and the ear cover (120). The pressure on/off is controlled by the user's inhaling/exhaling/air blowing, while the pressure applied is regulated by a pressure control device (65)

FIG. 5C-D are schematic illustrations, in an out of scale manner of different embodiments of the invention comprising a nostril apparatus (200). FIG. 5C illustrates the ear therapeutic device (100a), comprising a conduit (300) embodied as a hollow tubing system configured to permit the passage of fluid within. In this embodiment, the pneumatic pressure is provided by at least one motor (80) operating a plurality of pneumatic pumps (70a, 70b). The conduit comprises tubing connecting one pump (70a) to an ear cover (120) and another pump is connected to nostril at least a partially fitting insert (200). Additionally or alternatively, the nostril piece is reversibly replaceable with a nose piece fitting at least a portion of both nostrils (140). The pneumatic pressure provided by the pumps is controlled by at least one of the following: a motor velocity adjustor (85), enabling turning up/down the velocity of the motor, thereby adjusting the pressure buildup and the pressure buildup speed; one or more valves (50, 55) positioned along the conduit; additional pumps (75) connected in proximity to the nose mask (130) and/or ear cover (120); additional valves (55) can be placed at the airways in the pump exits. Additionally or alternatively, one or more of the valves is such as servo valve, predefined to close/open according to preset pressure values. Optionally, the valves are opened and/or closed in accordance to a treatment protocol or sub-protocol. In addition, the user can control at least one valve (50) manually. The device (100a) is configured to be operated by the user inhaling, exhaling, and/or air blowing into a mouth piece (110). In this embodiment the mouth piece is connected to an on/off button (60) and a pressure control valve (50) configured to respond to the user's exhaling, and/or air blowing. Reference is now made to FIG. 5D, schematically illustrating, in an out of scale manner, an embodiment of the ear therapeutic device comprising one pneumatic pump in fluid communication with both the nose piece (200), reversibly replaceable with a two nostril piece (140), and the ear cover (120). The pressure on/off is controlled by the user's inhaling/exhaling/air blowing, while the pressure applied is regulated by a pressure control device (65).

Reference is now made to FIG. 6A, schematically illustrating, in an out of scale manner an embodiment of the ear therapeutic device (100), including ear equalizing pressure means (500), and comprising a pressure regulating device (65). A motor (80) is configured to operate a pump (75) to apply fluid pressure through a tubing system (300). The pressure is controlled by a motor velocity controller slider (85), and/or by a pressure control device (85), connected to the tubing (300) adjacent to the mouth piece (110). The pressure control device is operable by the patient's/user applying positive or negative pressure by forcibly blowing air or forcibly inhaling. Additionally or alternatively, the device can be controlled by the patient's/user breathing velocity, pressure, time span of inhaling/exhaling or both, inhaling, exhaling, repeated breathing sequence and etc.

Reference is now made to FIG. 6B-D schematically illustrating, in an out of scale manner various embodiments of the pressure controller (65). The fluid is passed through a conduit (300) and enter the pressure control device through an entry port (45), and exit through an exit port (48). The device further comprises at least one pressure release valve (47) configured to regulate the pressure applied. The pressure control device responds to the fluid pressure passing through by moving a slide-able portion (42) accordingly, towards a contact element (41). The pressure providing means is configured to be normally closed. When the slide-able portion connects to the contact element (41) the device is turned on. When the pressure rises, a spring (43), connecting the slide-able element to the contact element, condenses further generating a response of application of higher pressure administration.

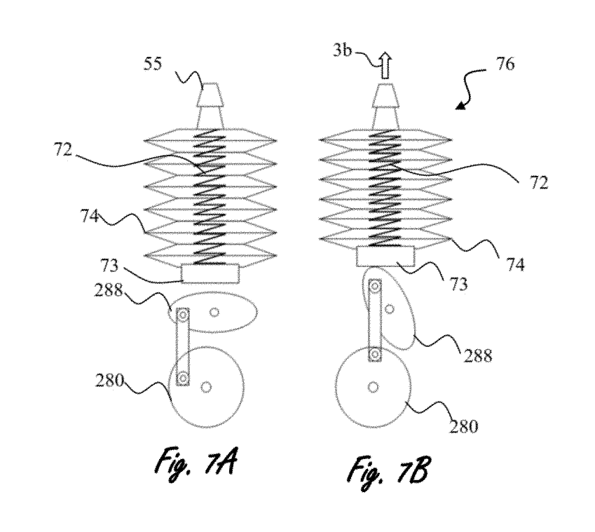

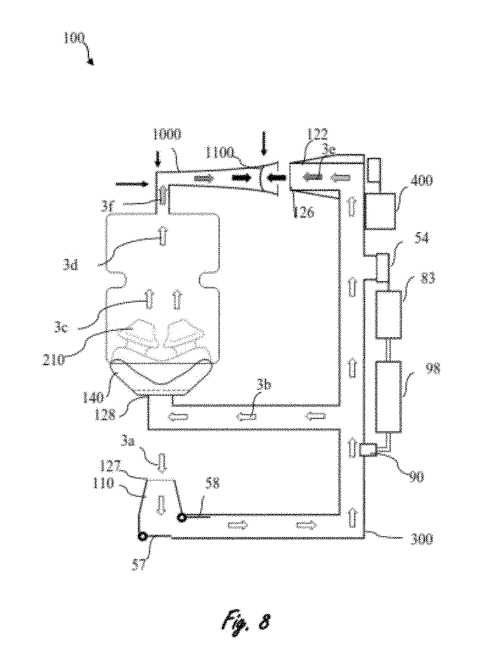

Reference is now made to FIG. 7A-B schematically illustrating, in an out of scale manner, an embodiment of pressure providing means (76). This embodiment can be, but not limited to the pressure providing means described in FIG. 5 (75, 70b, 70a). A motor is connected to a motor gear (280) transforming the rotating power of the motor to an up and down movement of an eccentric mechanism (288). The movement of the eccentric mechanism (288) provides intermittent contact between the bellow (74) and the force generated from the motor and transmitted by the motor gear (280). Additionally or alternatively, the bellow (74) is a manual pump, automated pump, piston, air compressor, flexible bag, vent or any combination thereof. The term “Eccentric” or “excenter” interchangeably refers hereinafter to a mechanism that converts rotary motion into reciprocating motion where the eccentric diameter is larger than the eccentricity. Further, the circular eccentric disc is rotating about a point that does not coincide with the axis center. When the motor rotates, the motor gear (280) translates the rotating motion by the eccentric mechanism (288) to an intermittent movement causing the excenter piece (288) to apply a sharp blow to the base (73) of the bellow, thereby compressing the bellow and therefore providing a positive pressure wave in the direction of arrow 3b. Following, the internal return spring (72) expands the bellow back to its original form thereby providing negative pressure. In addition the air exits through a nozzle (55), which in some embodiments can be provided with a valve useful for regulating the pressure passing through the nozzle. FIG. 7a illustrates the bellow (74) in an expanded position, while the eccentric mechanism (288) is not touching the bellow base (73) and the return spring (72) in a normally open form (expanded). FIG. 7b illustrates the bellow (74) in a condensed position, following contact by the eccentric mechanism (288) providing a force against the bellow base (73) and the return spring (72) in a condensed form.

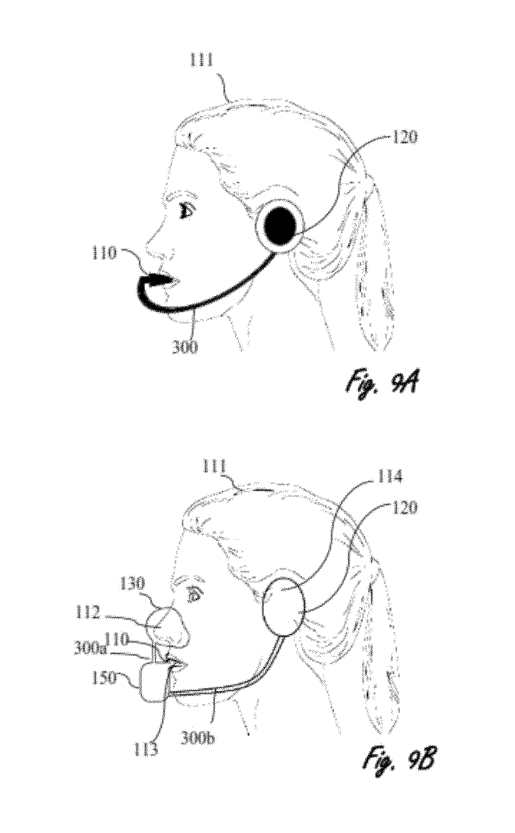

FIG. 8 is a schematic illustration, in an out of scale manner of an embodiment of the ear therapeutic device (100) comprising a conduit having three apertures (127, 126, 128), useful for providing pressure to the Eustachian tube (1000) from the ear connecting side and from the throat connecting side via the nasal cavity. The ear pressure equalizing means comprising at least one conduit (300) having at least one first end attachable to the ear aperture (126), at least one second end (127) connected to the mouth aperture and at least one third end (128) connected to the nose aperture. At least one first conduit end comprises an ear piece (122), and at least one second ear piece is connected to a mouth piece (110). The conduit (300) is configured to permit the passage of air from the mouth piece (110) to the ear piece (122), and to a nose piece (140) connected to the third aperture (128). The ear piece is configured to at least partially seal the external ear canal (1200), while allowing pneumatic pressure to pass through enabling application of positive or negative pressure on the ear drum (1100). The nose piece (140) comprises at least one element at least partially insertable to at least one nostril (210). The air pressure delivered through the conduit from the mouth piece along the arrows 3a arrives to the ear aperture along the arrow 3e and to the nasal cavity along the arrow 3b. In the nasal cavity the air pressure travels via (arrows 3c, 3d) the throat to (arrow 30 the inner opening of the Eustachian tube (1000). It is in the scope of the invention to provide pneumatic pressure to the patient nasal cavity thereby assisting in closure of the patient soft palate. The conduit (300) is further connected to a controller (98) designed to control the pneumatic pressure applied by the device (100). The controller is further connected to a release valve motor (83) and at least one release valve (54) configured to allow pressure release and pressure buildup when opened or closed accordingly. The pressured is also monitored by at least one pressure sensor (90), relaying the sensed information to such as the controller, at least one indicator, or a CRM. The device further comprises at least one vibrator (400), configured to provide oscillating vibrations to the ear by the ear piece. The vibrations can improve draining of fluids in the ear and the Eustachian tube (1000), promoting healing and/or pressure equalizing.

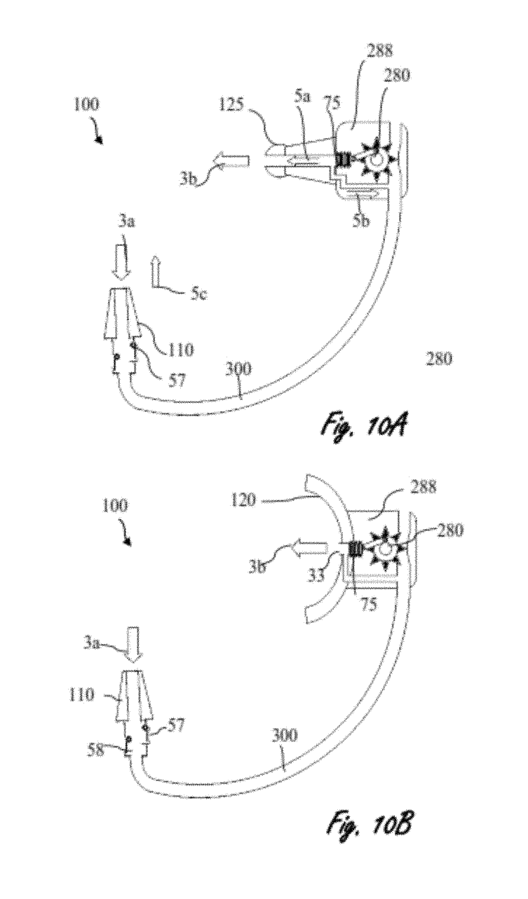

FIG. 9A is a schematic illustration, in an out of scale manner of an embodiment of the present invention worn by a patient (111). A conduit (300) configured to provide pressured fluid communication, comprising at least one first aperture connected to a mouth piece (110), and at least one second aperture connected to an ear piece (120). The patient (111) blows air into the mouth piece, the air is delivered through the conduit through the ear cover into the ear, thereby applying pressure to the ear drum. The pressure applied can be positive, negative, or both.

FIG. 9B is a schematic illustration, in an out of scale manner of an embodiment of the present invention worn by a patient, and connected to the patient's mouth (113), nose (112) and ear (114). A conduit (300a, 300b) configured to provide pressured fluid communication, comprising at least one first aperture connected to a mouth piece (110), and at least one second aperture connected to an ear piece (120). The patient (111) blows air into the mouth piece (110), the air is delivered through the conduit (300b) through the ear cover (120) into the ear (114), thereby applying pressure to the ear drum. Simultaneously, the pressure is applied though a third aperture, stemming from a divergence of the conduit (300a) connected to a nose cover (130) to the patient's nose (112). The pressure applied can be positive, negative, or both.

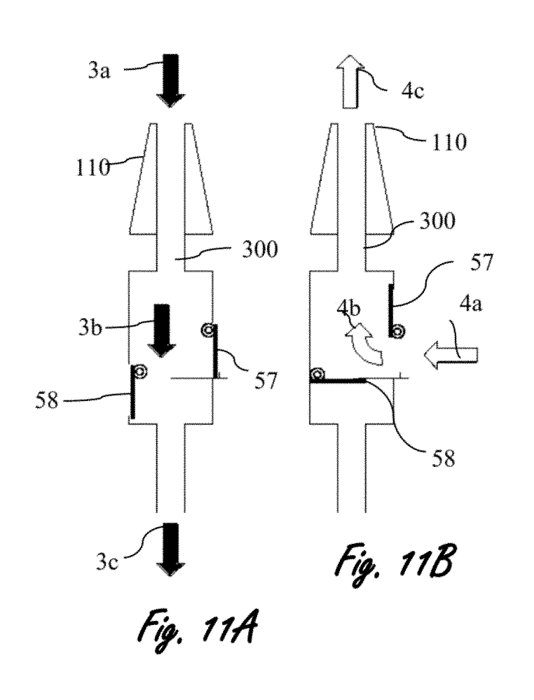

FIG. 10A is a schematic illustration, in an out of scale manner of an embodiment of the present invention operable by the patient's inhaling and exhaling, comprising an ear piece (120). In this embodiment, the ear piece comprises a pressure regulator, translating the fluid pressure (3a) applied by the user/patient blowing air through the mouth piece (110), into a conduit (300). The pressure is passed through a regulating device/gear (280) configured to translate the fluid pressure force into a rotating motion creating an oscillating translational pumping movement in the pumping sleeve (75). This pressure regulator (288) is used to enhance, reduce, or both the fluid pressure arriving (3b, 3c) at the exit port aperture (33) at the ear piece (120), at least partially insertable protruding portion (125). The returning fluid can bypass the pressure regulator as indicated by arrow 5b. The device (100) comprises at least one inhaling valve (57), and at least one exhaling valve (58), configured to allow the entry of external air when inhaling and diverting the air when exhaling into the conduit. Additionally or alternatively, the device (100) comprises at least one pressure valve further regulating the fluid pressure reaching the ear.

FIG. 10B is a schematic illustration, in an out of scale manner of an embodiment of the present invention, operable by the patient's inhaling/exhaling, comprising an at least partial facial cover (122). The facial cover is configured to cover at least a portion of the face, and can include covering at least apportion of the ear, mouth, nose, cheeks, jaw, forehead, head and any other feature of the head or face. In this embodiment, connected to the facial cover is a pressure regulator, translating the fluid pressure (3a) applied by the user/patient blowing air through the mouth piece (110), into a conduit (300). The pressure is passed through a regulating device/gear (280) configured to translate the fluid pressure force into a rotating motion creating an oscillating translational pumping movement in the pumping sleeve (75). This pressure regulator (288) is used to enhance, reduce, or both the fluid pressure arriving (3b) at the exit port aperture (33) at the facial cover (122). The device (100) comprises at least one inhaling valve (57), and at least one exhaling valve (58), configured to allow the entry of external air when inhaling and diverting the air when exhaling into the conduit.

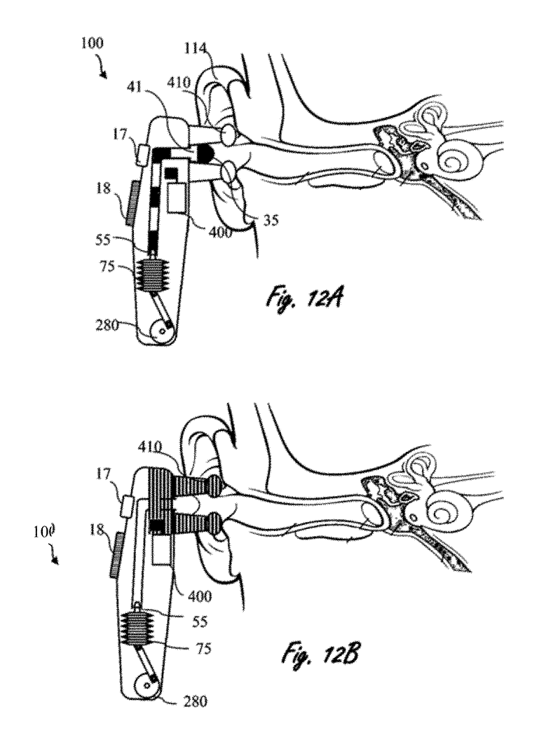

FIG. 11A-B is a schematic illustration, in an out of scale manner of an embodiment of a mouth piece (110) comprising inhalation and exhalation valves (57, 58). FIG. 9A illustrates that when exhaling, through the mouth piece (110) the fluid pressure is passed in the direction of the arrow 3a, and through the conduit (300). The conduit comprises a set of valves configured to divert and direct the passage of fluid as indicated by arrows 3b and 3c within the conduit. When exhaling, the exhaling valve (58) seals the exit of air from the conduit outward while permitting the fluid pressure to advance in the direction or the arrow. The inhalation valve (57) remains closed, sealing the exit of air from the conduit. When inhaling, as illustrated in FIG. 9B, the inhalation valve (57) swings open to allow the entry of external air through the conduit (300) to the mouthpiece (110) in the direction of the arrows 4a, 4b, 4c. The exhalation valve (58) blocks the passage of air in the conduit, thereby blocking the formation of negative pressure in the ear/nose.

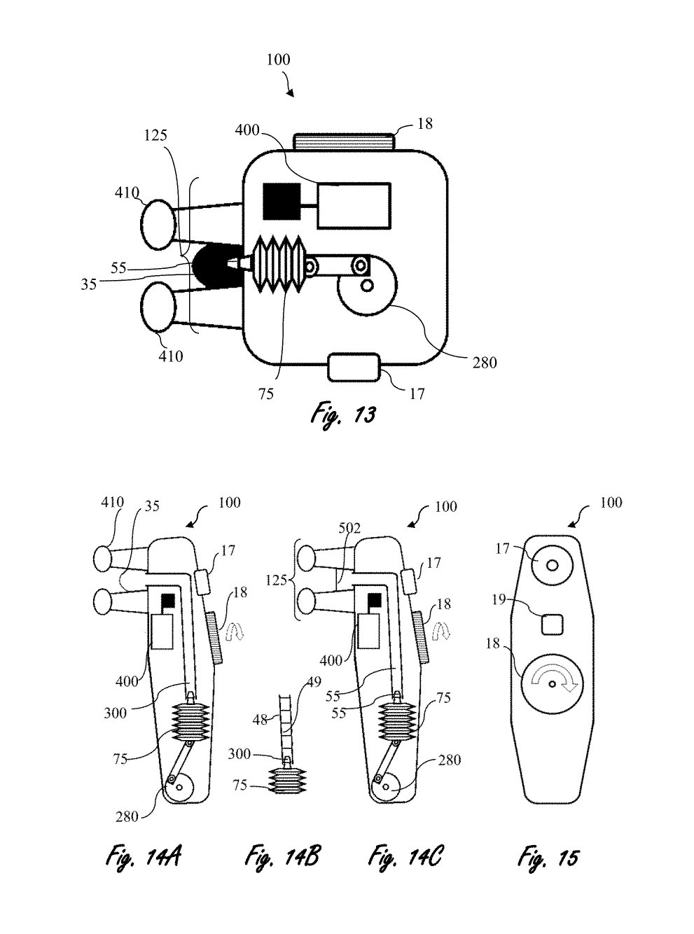

FIG. 12A-B are schematic illustrations, in an out of scale manner of different embodiments of the invention comprising an ear vibrator. The ear therapeutic device (100), comprising at least one fluid pressure pump (75) regulated by a pressure regulator (280) gear connected to a motor, configured to administer a plurality of protocols and sub protocols of pressure (continuous, oscillating, intermittent or any combination thereof). The fluid pressure passes through at least one conduit (41) and operative to inflate an inflatable balloon or flexible membrane (35) at the interface of the ear therapeutic device (100) with the ear external canal. The device further comprises at least one vibrator (400) and at least one vibrating element (410), interfacing with the ear (114). The device (100) is configured to administrate protocols and/or sub protocols of oscillating vibrations to the ear (114) thereby assisting fluid draining from the ear portions such as the Eustachian tube and the middle ear. Additionally or alternatively, the vibrations are administered alone or simultaneously with fluid pressure protocols or sub protocols. The device further comprises at least one pressure valve configured to regulate the pressure applied (55). Additionally or alternatively, the device comprises a user interface including a pressure pulses regulating turnable button (18), and at least one on/off button (17).

FIG. 13 is a schematic illustration, in an out of scale manner of an embodiment of the top view of the invention (100), comprising pneumatic pressure means (500) and vibration means (400) as part of the ear piece (125). The pressure means comprise at least one pressure pump (75) providing pneumatic pressure configured to inflate/deflate at least one inflatable balloon (35). The pressure can be adjusted by at least one pressure valve (55) attached at the interface of the pneumatic pump (35) and the inflatable balloon (35). The vibration means comprise at least one vibrator (400) and at least one vibrating element (410). The device (100) further comprises at least one pressure pulse regulator (18) adjustable by the user, and at least one on/off button (17). The Pump is connected by a gear (280) to a motor. Additionally or alternatively, the pump can be operated manually, automatically or both.

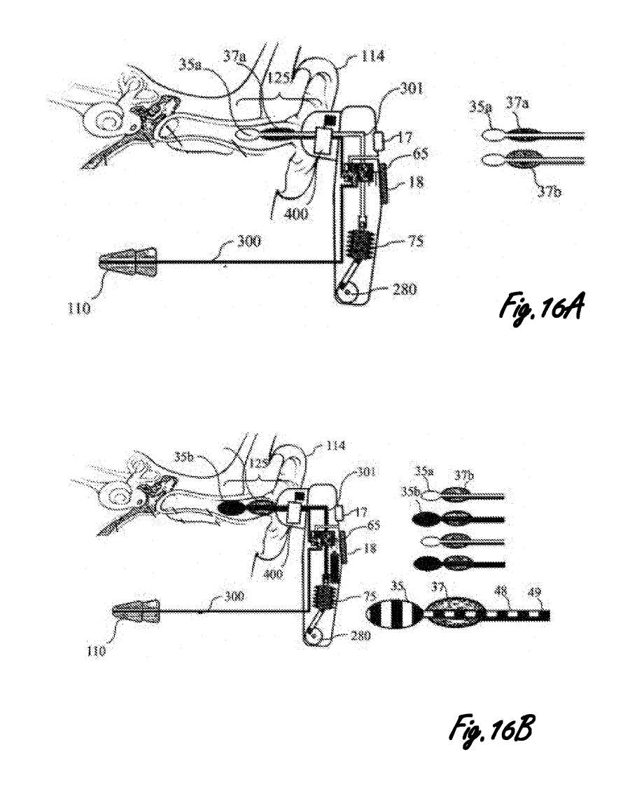

FIG. 14 A-C are schematic illustrations, in an out of scale manner of different embodiments of the ear therapeutic device comprising an inflatable membrane/balloon (35) configured to administer pressure to at least a portion of the patients' ear, and oscillating vibration providing means. The ear therapeutic device (100), comprising at least one fluid pressure pump (75) regulated by a gear (280) configured to translate the turning movement of a motor to a pulsating motions, configured to administer a plurality of protocols and sub protocols of pressure (continuous, oscillating, intermittent, pulsating or any combination thereof). The fluid pressure passes through at least one conduit (300) and operative to inflate an inflatable balloon or flexible membrane (35) at the interface of the ear therapeutic device (100) with the ear external canal. The ear piece (125) comprises both a pressure administrating inflatable membrane (35) and at least one vibrating element (410). The device further comprises at least one vibrator (400) and at least one vibrating element (410), interfacing with the ear (114). The device (100) is configured to administrate protocols and/or sub protocols of oscillating vibrations to the ear (114) thereby assisting fluid draining from the ear portions such as the Eustachian tube and the middle ear. Additionally or alternatively, the vibrations are administered alone or simultaneously with fluid pressure protocols or sub protocols. The device further comprises at least one pressure valve configured to regulate the pressure applied (55). Additionally or alternatively, the device comprises a user interface including a pressure pulses regulating button (18), and at least one on/off button (17). FIG. 12B illustrates the conduit (300) connected to a pump (75) via at least one valve, providing pulsating pneumatic pressure. As a non-limiting example, the pressure is of a specific value at area 49, and at a lower value at area 48.

FIG. 15 is a schematic illustration, in an out of scale manner of an embodiment of the invention (100) in a side view, showing an example of a user interface. In this embodiment the user interface comprises a pressure regulating button (18), an on/off switch (17) and a program selector (19) for selecting a treatment protocol.

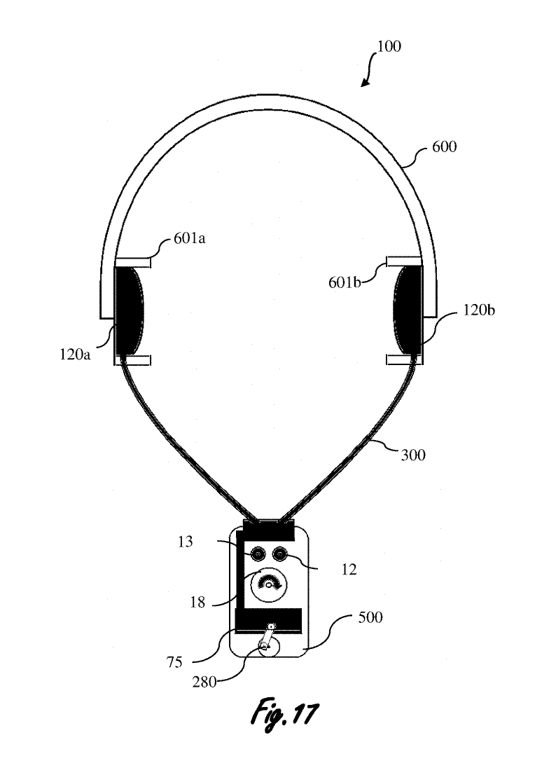

FIG. 16 A-B is a schematic illustration, in an out of scale manner of an embodiment of the ear therapeutic device (100) in a side view. In this embodiment, the ear device (100) comprises two conduits (300, 301) configured to control and regulate pressure administered to the ear. One first conduit (300) comprising at least two end apertures. One first end connected to a mouth piece (110) configured to allow fluid connection applied by a user's mouth via the mouth piece (110), through the conduit (300) to an inflatable membrane (37a, b) connected to at least one second conduit aperture. The inflatable membrane (37a, b) is configured to at least partially seal the external ear auditory canal. The user can regulate the closure of the external auditory canal by such as inhaling, exhaling, forcibly blowing air, through the mouth piece (100), thereby inflating and/or deflating the membrane (37a, b). A second conduit (301) comprising at least ends, each having an aperture, configured to allow fluid connection therebetween. At least one first end connected to a pressure means such as a pump, bellow, piston, operational manually, automatically or both. In this embodiment a motor is connected to a gear (280) translating the rotational force to a pulsating force activating a pump (75) configure to inflate/deflate an inflatable balloon or flexible membrane (35a, b), thereby administrating pressure to the ear. The ear piece (125) comprises at least two inflatable membranes (37a, b, 35a, b) at least partly inserted into the external auditory canal. The first membrane (35) inserted at least partly within the ear and is configured to be in at least an inflated configuration (35b) and deflated configuration (35a) and any partly inflated configuration. The user can regulate the pressure administered to the ear by controlling the motor velocity by at least one interface button (18), an on/off button (17). Importantly, the pressure applied by the first membrane (35) is further regulated by at least partly sealing the ear external canal by the second membrane (37), inflated/deflate by the user. When the second membrane is deflated (37a) the first membrane is inflated (35b) with less resistance since the surrounding air can be pushed out of the ear to the external environment. When the second membrane is inflated (37b), thereby sealing the ear canal, the pressure administered to the ear by inflating the first membrane (35b) is greater than when the ear canal is open. The air pressure administered by the mouthpiece (110) can also be regulated by a pressure control device (65) connected to at least one conduit (300, 301) providing both on/off switch and pressure level control, responsive to the user's inhaling, exhaling, forcefully breathing or blowing air through the mouthpiece (110). The ear device (100) further comprises at least one vibration providing means such as a vibrator (400), configured to provide oscillating vibrations to the ear through at least a portion of the ear piece (125). FIG. 16A illustrates a configuration where one membrane (35a) is at least partly inserted into the external auditory canal, and presented in a deflated configuration. A second membrane (37a) is at least partly inserted into the external ear canal entrance, in a deflated configuration (37a), external to the first membrane (35a). FIG. 16B illustrates a configuration where the external membrane is inflated (37b) thereby at least partly sealing the ear external auditory canal. This configuration enables administrating pneumatic pressure by inflating/deflating a second membrane (35a, b) located at least partly within the external ear canal between the ear drum and the first membrane (37).

Additionally or alternatively, when the ear canal is sealed, by an inflated sealing membrane (37b) a plurality of pressure and or vibration protocols and sub protocols be administered to the patient's ear, including alternating pressure waves (48,49) provided by inflating and/or deflating the inner membrane (35).

Additionally or alternatively, the inner membrane (35) and or the sealing membrane (37) is connectable to at least one pressure means such as a pump, piston, bellow, compressor, vent, a user's respiratory system, a flexible bag and etc.

Additionally or alternatively, the ear device (100), at least one pressure means, at least one conduit, at least one inflatable/deflatable membrane, at least one pressure control device, and any combination thereof, comprises at least one valve configured to regulate the pressure administered by the ear device.

Additionally or alternatively, the ear device (100) comprises at least one pressure sensor configured to sense the pressure administered by the pressure means. Additionally or alternatively, the sensor relays information to at least one indicator, selected from a group consisting of visual, auditable, sensible and any combination thereof. Additionally or alternatively, the sensor relays sensed information to a selected from a group consisting of: a CRM, a remote computer, a remote control, an emergency shut off system, a pressure valve, a pressure control device, at least one indicator, or any combination thereof.

FIG. 17 is a schematic illustration, in an out of scale manner of an embodiment of the invention comprising a remote control system. In this embodiment a headset (600) fitted to reside on a patient head, is provided, comprising at least one placement (601a, 601b) configured to house at least one ear piece (120a, 120b). The ear piece is in fluid communication with at least one pressure equalizing means (500) such as a pneumatic pump (75) by a conduit (300), having at least one aperture for the entry of fluid and at least one aperture connected to at least one ear piece (120). The pneumatic pump (75) is connected to a motor providing torque translated to a pulsating movement by a gear (280) element. The pump, motor and operational buttons (13, 12) are located remote from the ear, in a remote control station/hand held device.

1.-40. (canceled)

41. An ear therapeutic device (ETD) comprising:
a. at least one conduit comprising at least one first end configured for receiving an airflow blown thereinto and at least one second end configured for external attachment to the ear aperture being in a fluid communication therebetween; and
b. one or more vibrations means;
wherein said one or more vibrations means comprises an eccentric mechanical vibrator driven by an electric motor configured for providing mechanical vibrations; said eccentric mechanical vibrator is in a mechanical contact with said conduit.

42. The ETD according to claim 41, wherein at least of the following is true:
a. said airflow is created by a patient exhalation/inhalation or an air blower;
b. said ETD further comprises at least one patient interfacing piece configured to be reversibly attached to at least a portion of a patient's organ selected from a group consisting of: nose, nasal bridge, nostril, ear, ear canal, cheek, forehead, temple, neck, inner throat, head, mouth, philtrum, glabella, nasion, chin, face, jaw, and any combination thereof;
c. said device further comprises at least one element, connected to at least one conduit end selected from the group consisting of: a mouth piece configured to permit fluid communication from said patient's or user's mouth to said conduit; an ear piece configured to at least partially seal said patient's ear canal from air external to said conduit and permit fluid communication from said conduit to said patient's ear;
d. a connection to an external pneumatic pressure means selected from a group consisting of: a pneumatic compressor, a manual pump, an automatic pump, an air blower, vacuum, bellow, piston, flexible bag, and any combination thereof;
e. a nose piece configured to permit fluid communication into and out of said patient's nose and through said conduit, a reversibly attachable facial mask configured to at least partially seal at least a portion of said patient face from external air, configured to permit fluid communication to at least a portion of said patients face from said conduit.

43. The ETD according to claim 42, wherein at least of the following is true:
a. said pressure provided by one or more said protocols is a positive pressure, a negative pressure or a sequence thereof comprising both;
b. said patient interfacing piece comprises at least one aperture, configured to permit fluid communication therethrough; and
c. said patient interfacing piece is configured to at least partially seal a patient's aperture selected from the group consisting of: mouth, at least one nostril, external auditory ear canal, ear, nose, and any combination thereof from fluid communication with the external air.

44. The ETD according to claim 41, wherein at least of the following is true:
a. said conduit further comprises at least one turnable hinge;
b. at least a portion of said conduit is made of a material selected from the group consisting of: a flexible material, at least partially transparent material, a sterilizable material, a disposable material, and any combination thereof;
c. said ETD further comprises at least one valve configured to regulate a pressure administered by said pressure equalizing means;
d. one or more said valve is selected from the group consisting of: a pressure tuning valve, a pressure release valve, a pressure buildup valve, and any combination thereof;
e. said conduit comprises at least one pressure regulating valve operative by said patient inhaling, exhaling, or both;
f. said conduit comprises at least on/off switch configured to be controlled by said patient inhaling, exhaling or both;
g. said ETD is configured to be controlled by a device selected from the group consisting of: a remote control, a remote computer, a cellular phone, a PDA, a tablet, cloud computing, remote server, and any combination thereof;
h. said ETD comprises at least one operating system configured to control means selected from the group consisting of: one or more said vibration means, one or more said pressure equalizing means, one or more said valves, and any combination thereof.

45. The ETD according to claim 44, wherein said operating system is configured to control said vibration parameter selected from a group consisting of: amplitude, frequency, duration, velocity, wavelength, waveform, and any combination thereof.

46. The ETD according to claim 45, wherein said ETD comprises at least one first vibration means and at least one second vibration means, further wherein said control system is configured to control each vibration means independently.

47. The ETD according to claim 41, wherein at least of the following is true:
a. said vibration means is configured to provide vibrations at a set of frequencies ranging from about 0.1 Hz to about 20 KHz;
b. said vibration means is configured to provide vibration of at least one frequency in a value ranging from about 0.1 Hz to about 20 KHz;
c. said vibration means are selected from a group consisting of: at last one vibrator, at least one acoustic generator, at least one eccentric weight, at least one piston, at least one shaker, and any combination thereof;
d. said pressure means are configured to provide pressure ranging from about (−) 100 cmH₂O to about (+) 100 cmH₂O; and
e. said ETD comprises at least one sensor selected from the group consisting of: a patient monitoring sensor, a pressure sensor, a vibration sensor, and any combination thereof.

48. The ETD according to claim 47, wherein said patient monitoring sensor is selected from a group consisting of: an ear drum pressure sensor, a tissue vibration sensor, a breathing sensor, a cardiovascular sensor, a pressure sensor, and any combination thereof.

49. The ETD according to claim 47, wherein said sensor is configured to relay sensed information to at least one indicator selected from a group consisting of: auditable, sensible, visual, and any combination thereof.

50. The ETD according to claim 49, wherein at least of the following is true:
a. said sensor is configured to relay sensed information to said operating system;
b. said one or more pressure equalizing means is configured to provide positive pressure, negative pressure, or both;
c. said air blower is selected from the group consisting of: at least one automatic air pump, at least one manual pneumatic pump, a vent, a piston, a bellow, a flexible bag, and any combination thereof;
d. said ETD further comprises at least one data logger.

51. The ETD according to claim 41, wherein said ETD further comprises at least one processor in communication with a computer readable medium (CRM); the processor executes a set of operations received from the CRM; the set of operations are:
a. receiving a treatment protocol; and,
b. operating selected from a group consisting of: said pressure equalizing means, said vibration means, at least one valve, and any combination thereof according to said treatment protocol.

52. The ETD according to claim 51, wherein said ETD further executes the following set of operations:
a. receiving information values relayed by at least one said sensor;
b. comparing said information values relayed by at least one said sensor to said operated treatment protocol values; and,
c. if information relayed by at least one said sensor is different than information values of said treatment protocol, adjusting said values operated by a selected from a groups consisting of: said pressure equalizing means, said vibration means, at least one valve, and any combination thereof;

53. The ETD according to claim 41, wherein at least of the following is true:
a. said ETD further comprises wireless communication means, wired communication means or both; and
b. said ETD further comprises at least one emergency shutoff mechanism.

54. The ETD according to claim 53, wherein said wireless communication means are selected from a group consisting of: receiver, transmitter, transceiver, blue tooth system, cellular phone, Wi-Fi system, and any combination thereof.

55. The ETD according to claim 41, wherein said device further comprises at least one emergency shutoff mechanism.

56. The ETD according to claim 55, wherein said emergency mechanism is configured to stop the vibration, air pressure or both when detecting at least one of the following:
a. said pressure equalizing means providing pressure higher or lower than a predefined value range;
b. said vibration means provides vibration having a parameter selected from a group consisting of: frequency, duration, amplitude, waveform, wavelength, and any combination thereof, is of a value lower or higher than a predefined value range; and,
c. at least one said sensor senses a value lower or higher than a predefined value range.

57. A method for equalizing ear pressure; said method comprising steps of:
a. obtaining an ear therapeutic device (ETD), useful for providing artificially induced vibrations, pneumatic pressure, or both, to at least a portion of a patient's ear, comprising:
i. at least one conduit comprising at least one first end configured for receiving an airflow blown thereinto and at least one second end configured for external attachment to the ear aperture, said conduit configured to permit fluid communication therebetween;
ii. one or more vibrations means for providing vibrations; said one or more vibrations means comprising an eccentric mechanical vibrator driven by an electric motor configured for providing mechanical vibrations; said eccentric mechanical vibrator being in a mechanical contact with said conduit;
b. blowing an airflow into at least a portion of one said first end;
c. reversibly attaching at least a portion of said second end to at least a portion of said patient's ear;
d. operating at least one said eccentric mechanical vibrator for administering mechanical vibrations and,
e. administering at least one of:
i. equalizing pressure to said patient' ear;
ii. artificially induced vibrations along said conduit and into said patient Eustachian tube.

58. The method according to claim 57, wherein at least of the following is true:
a. said step blowing said airflow is carried out by a blower or patient's exhalation/inhalation; and
b. said method comprises the step of providing said ETD comprising at least one said vibration means for administering oscillating vibration, and administering oscillating vibrations, thereby artificially induced vibrations propagate into said patient Eustachian tube.

59. The method according to claim 57, additionally comprising the step of configuring said ETD to providing one or more protocols comprising administering a selected from a group consisting of: said oscillating vibrations by one or more vibrations means, pressure by at one or more said pressure equalizing means, and any combination thereof.

60. The method according to claim 57, additionally comprising the step of administering vibrations by said vibration means at a set of frequencies, at least one frequency, or both, in a value ranging from about 0.1 Hz to about 20 KHz.
